(19) United States
(12) Patent Application Publication
(10) Pub. No.: US 2019/0081372 A1
(43) Pub. Date: Mar. 14, 2019

(54) MODULAR BATTERY SYSTEM TO PROVIDE POWER TO ELECTRIC VEHICLES

(71) Applicant: SF Motors, Inc., Santa Clara, CA (US)

(72) Inventors: Nathalie Capati, Santa Clara, CA (US); Duanyang Wang, Santa Clara, CA (US); Jacob Heth, Santa Clara, CA (US); Binbin Chi, Santa Clara, CA (US)

(21) Appl. No.: 16/118,362

(22) Filed: Aug. 30, 2018

Related U.S. Application Data
(60) Provisional application No. 62/557,689, filed on Sep. 12, 2017.

(51) Int. Cl. H01M 10/63; H01M 10/48; H01M 2/10; H01M 10/613; H01M 10/6554; H01M 10/625; B60L 11/18

(52) U.S. Cl. CPC H01M 10/63; H01M 10/482; H01M 2/1077; B60L 11/187; H01M 10/6554; H01M 10/625; B60L 11/1877; H01M 10/613

(57) ABSTRACT

Provided herein is an electric vehicle battery pack system that powers electric vehicles. The electric vehicle battery pack system can include a battery pack to power an electric vehicle. The battery pack can reside in the electric vehicle and include a plurality of battery modules. The plurality of battery modules can include a plurality of battery blocks. The battery blocks can have a plurality of cylindrical battery cells connected in parallel. A battery module of the plurality of battery modules can include a battery monitoring unit. The battery module can include a cold plate coupled with the first battery module and the battery monitoring unit. The cold plate can receive control signals from the battery monitoring unit. The control signals can identify a battery module and identify a climate control parameter for the battery module. The cold plate can apply the climate control parameter to the battery module.

### RELATED APPLICATION

The present application claims the benefit of priority under 35 U.S.C. § 119(e) to U.S. Provisional Application 62/557,689, titled “SMALL FORMAT BASED MODULAR BATTERY SYSTEM”, filed on Sep. 12, 2017. The entire disclosure of which is incorporated herein by reference in its entirety.

### BACKGROUND

Vehicles such as automobiles can include power sources. The power sources can power motors or other systems of the vehicles.

### SUMMARY

In at least one aspect, a system to power an electric vehicle is provided. The system can include a battery pack to power an electric vehicle. The battery pack can reside in the electric vehicle and include a plurality of battery modules. Each of the plurality of battery modules can include a plurality of battery blocks. Each of the plurality of battery modules can include a pair of battery module terminals. Each pair of battery module terminals can have a battery module voltage across the pair of battery module terminals. Each of the battery blocks can have a plurality of cylindrical battery cells connected in parallel, and can have a pair of battery block terminals with a defined maximum voltage across the pair of battery block terminals that is less than the battery module voltage. Each of the cylindrical battery cells can have a pair of battery cell terminals. Each pair of battery cell terminals can have the defined maximum voltage across the pair of battery cell terminals. A first battery module of the plurality of battery modules can include a battery monitoring unit coupled with the first battery module of the plurality of battery modules. The first battery module of the plurality of battery modules can include a cold plate coupled with the first battery module and the battery monitoring unit. The cold plate can receive control signals from the battery monitoring unit to provide levels of cooling to at least a subset of the plurality of battery blocks of the first battery module.

In at least one aspect, an electric vehicle battery pack system that powers electric vehicles is provided. The electric vehicle battery pack system can include a battery pack to power an electric vehicle. The battery pack can reside in an electric vehicle and include a plurality of battery modules. Each of the plurality of battery modules can have a plurality of battery blocks. Each of the plurality of battery modules can have a pair of battery module terminals. Each pair of battery module terminals can have a battery module voltage across the pair of battery module terminals. Each of the battery blocks can have a plurality of cylindrical battery cells connected in parallel. Each of the battery blocks can have a pair of battery block terminals with a defined maximum voltage across the pair of battery block terminals that is less than the battery module voltage. Each of the cylindrical battery cells can have a pair of battery cell terminals. Each pair of battery cell terminals can have the defined maximum voltage across the pair of battery cell terminals. A battery monitoring unit can couple with a first battery module of the plurality of battery modules. A cold plate can couple with the first battery module and the battery monitoring unit. The battery monitoring unit can provide a first control signal, the first control signal identifies a first battery module of the plurality of battery modules and identifies a first climate control parameter for the first battery module. Based on the first control signal, the cold plate can apply the first climate control parameter to the first battery module. The battery monitoring unit can provide a second control signal. The second control signal can identify a second battery module of the plurality of battery modules and identify a second climate control parameter for the second battery module. Based on the second control signal, the cold plate can apply the second climate control parameter to the second battery module.

In at least one aspect, a method is provided. The method can include arranging a plurality of cylindrical battery cells to form a battery block. Each of the plurality of cylindrical battery cells can have a pair of battery cell terminals. The battery block can have a pair of battery block terminals. Each pair of the battery cell terminals can have a defined maximum voltage across the respective pair of battery cell terminals. The method can include electrically connecting the plurality of cylindrical battery cells in parallel, to cause each pair of the battery block terminals to have the defined maximum voltage across the respective pair of battery block terminals. The method can include combining the battery block with one or more other battery blocks to form a battery module. The battery module can have a pair of battery module terminals. The pair of battery module terminals can have a maximum voltage across the respective pair of battery module terminals that is greater than the defined maximum voltage across each pair of the battery block terminals. The method can include combining the battery module combinable with one or more other battery modules to form a battery pack having a battery pack capacity and battery pack voltage. The battery module and the one or more other battery modules can be removable from the battery pack and replaceable by another battery module. The method can include coupling a battery monitoring unit to the battery module. The method can include disposing a cold plate between a surface of the battery module and the battery monitoring unit. The cold plate can couple with the first battery module and the battery monitoring unit. The cold plate can receive control signals from the battery monitoring unit to provide levels of cooling to at least a subset of the plurality of battery blocks of the first battery module. The method can include providing, by the battery monitoring unit, a first control signal to the cold plate. The first control signal can identify a first battery module of the plurality of battery modules and identifies a first climate control parameter for the first battery module. The method can include applying, by the cold plate and based on the first control signal, the first climate control parameter to the first battery module. The method can include providing, by the battery monitoring unit, a second control signal. The second control signal can identify a second battery module of the plurality of battery modules and can identify a second climate control parameter for the second battery module. The method can include applying, by the cold plate and based on the second control signal, the second climate control parameter to the second battery module.

In another aspect, a method to provide an electric vehicle battery pack system that powers electric vehicles is provided. The method can include providing an electric vehicle battery pack system that powers electric vehicles. The electric vehicle battery pack system can include a battery pack to power an electric vehicle. The battery pack can reside in an electric vehicle and include a plurality of battery modules. Each of the plurality of battery modules can have a plurality of battery blocks. Each of the plurality of battery modules can have a pair of battery module terminals. Each pair of battery module terminals can have a battery module voltage across the pair of battery module terminals. Each of the battery blocks can have a plurality of cylindrical battery cells connected in parallel. Each of the battery blocks can have a pair of battery block terminals with a defined maximum voltage across the pair of battery block terminals that is less than the battery module voltage. Each of the cylindrical battery cells can have a pair of battery cell terminals. Each pair of battery cell terminals can have the defined maximum voltage across the pair of battery cell terminals. A battery monitoring unit can couple with a first battery module of the plurality of battery modules. A cold plate can couple with the first battery module and the battery monitoring unit. The battery monitoring unit can provide a first control signal, the first control signal identifies a first battery module of the plurality of battery modules and identifies a first climate control parameter for the first battery module. Based on the first control signal, the cold plate can apply the first climate control parameter to the first battery module. The battery monitoring unit can provide a second control signal. The second control signal can identify a second battery module of the plurality of battery modules and identify a second climate control parameter for the second battery module. Based on the second control signal, the cold plate can apply the second climate control parameter to the second battery module.

In another aspect, an electric vehicle is provided. The electric vehicle can include an electric vehicle battery pack system that powers electric vehicles is provided. The electric vehicle battery pack system can include a battery pack to power an electric vehicle. The battery pack can reside in an electric vehicle and include a plurality of battery modules. Each of the plurality of battery modules can have a plurality of battery blocks. Each of the plurality of battery modules can have a pair of battery module terminals. Each pair of battery module terminals can have a battery module voltage across the pair of battery module terminals. Each of the battery blocks can have a plurality of cylindrical battery cells connected in parallel. Each of the battery blocks can have a pair of battery block terminals with a defined maximum voltage across the pair of battery block terminals that is less than the battery module voltage. Each of the cylindrical battery cells can have a pair of battery cell terminals. Each pair of battery cell terminals can have the defined maximum voltage across the pair of battery cell terminals. A battery monitoring unit can couple with a first battery module of the plurality of battery modules. A cold plate can couple with the first battery module and the battery monitoring unit. The battery monitoring unit can provide a first control signal, the first control signal identifies a first battery module of the plurality of battery modules and identifies a first climate control parameter for the first battery module. Based on the first control signal, the cold plate can apply the first climate control parameter to the first battery module. The battery monitoring unit can provide a second control signal. The second control signal can identify a second battery module of the plurality of battery modules and identify a second climate control parameter for the second battery module. Based on the second control signal, the cold plate can apply the second climate control parameter to the second battery module.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not necessarily intended to be drawn to scale. Like reference numbers and designations in the various drawings indicate like elements. For purposes of clarity, not every component may be labelled in every drawing. In the drawings:

FIG. 1 depicts an isometric view of an illustrative embodiment of a battery module for providing energy storage;

FIG. 2 depicts an isometric view of an illustrative embodiment of a battery block for providing energy storage;

FIG. 3 depicts an exploded view of a top view of an illustrative embodiment of a system for providing energy storage;

FIG. 4 depicts a top view of an illustrative embodiment of a system for providing energy storage;

FIG. 5 depicts an isometric view of an illustrative embodiment of a battery pack for providing energy storage;

FIG. 6 depicts another view of an illustrative embodiment of a battery pack for providing energy storage;

FIG. 7 is a block diagram depicting a cross-sectional view of an illustrative embodiment of an electric vehicle installed with a battery pack;

FIG. 8 is a flow diagram depicting an illustrative embodiment of a method for providing an energy storage device;

FIG. 9 is a flow diagram depicting an illustrative embodiment of a method to provide battery blocks; and

FIG. 10 is a block diagram depicting an illustrative embodiment of electric vehicle battery pack system that powers electric vehicles.

### DETAILED DESCRIPTION

Following below are more detailed descriptions of various concepts related to, and implementations of, methods, apparatuses, devices, and systems electric vehicle battery pack system that powers electric vehicles. The various concepts introduced above and discussed in greater detail below may be implemented in any of numerous ways.

Systems and methods described herein are directed towards modular battery units referred to herein as battery modules, that can be formed using a plurality of battery blocks, with each of the battery blocks having a plurality of battery cells. The design and dimensions of the battery cells can be standardized such that the battery cells can be easily and individually repaired, replaced, or maintained. A plurality of the battery modules, as described herein, can be included together as a battery pack for powering an electric vehicle.

The battery modules can each include a cold plate (e.g., cooling system, climate control system) that can be a component of the respective battery module or battery pack or independent from the respective battery module or battery pack. For example, each battery module or battery pack can include at least one cold plate, at least one cell holder and at least one battery monitoring unit that measures various types of data (e.g., temperature data, voltage data, current data) and can control the corresponding battery module or battery block. Multiple battery blocks can be packaged as a single battery module and can be installed a single unit, such as but not limited to, installed in a drive unit of an electric vehicle system. The battery module can include quick disconnects and be designed such that battery cells or battery blocks can be easily and individually removed or replaced to meet or extend a lifetime warranty of the respective battery pack.

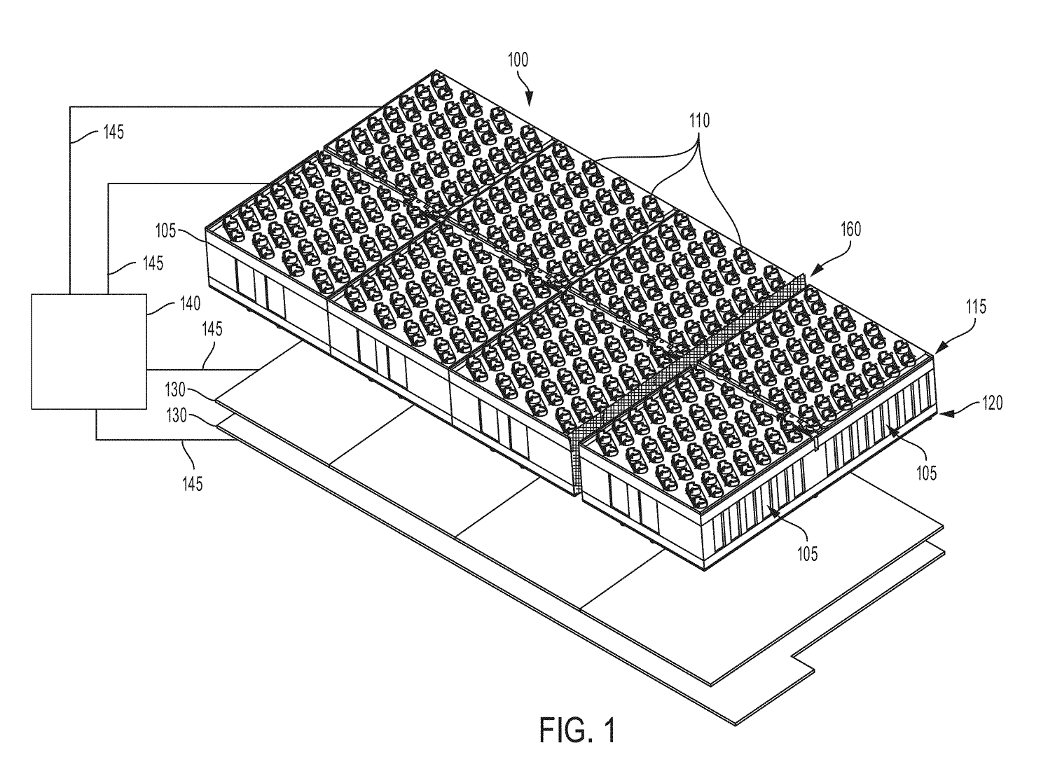

FIG. 1, among others, depicts an isometric view of an example embodiment of a battery module 100 is depicted. A battery module 100 as described herein can refer to a battery system having multiple battery blocks 105 (e.g., two or more). For example, multiple battery blocks 105 can be electrically coupled with each other to form a battery module 100. The battery modules 100 can be formed having a variety of different shapes. For example, the shape of the battery modules 100 can be determined or selected to accommodate a battery pack within which a respective battery module 100 is to be disposed. The shape of the battery modules 100 may include, but not limited to, a square shape, rectangular shape, circular shape, or a triangular shape. Battery modules 100 in a common battery pack can have the same shape. One or more battery modules 100 in a common battery pack can have a different shape from one or more other battery modules 100 in the common battery pack.

Each of the battery blocks 105 include a first cell holder 115 and a second cell holder 120 with the plurality of battery cells 110 disposed between or coupled between the first cell holder 115 and the second cell holder 120. Each battery module 100 (e.g., modular or standardized battery module) can have or couple with an independent or dedicated cold plate 130, or battery monitoring unit 140 that can measure or control the corresponding battery module 100 and battery module 100 components (e.g., battery cells 110, battery blocks 105). For example, a cold plate 130 can be coupled with the battery module 100 to provide cooling or temperature control to the battery cells 110 forming the respective battery module 100. For example, the cold plate 130 can be coupled with a second side (e.g., bottom side, bottom end) of the battery module 100. The cold plate 130 can include a single cold plate 130 coupled with each of the battery blocks 105 forming the battery module 100 or the cold plate 130 can include multiple cold plates 130 (e.g., FIG. 1). The multiple cold plates 130 can include two or more cold plates 130 layered on top of each other to form a multilayered cold plate 130. The multilayered cold plates 130 can couple with the battery module 100. The multiple cold plates 130 can include multiple independent cold plates 130, with each cold plate 130 coupled with at least one of the battery blocks 105 of the battery module 100. The cold plate 130 can include a single cooling zone or multiple cooling zones. For example, the cold plate 130 can include at least one cooling zone coupled with at least one battery block 105. The cold plate 130 can include a single cooling zone coupled with each of the battery blocks 105 of the battery module 100.

Battery blocks 105 can be held together using one or more cell holders 115, 120. For example, a single one of cell holders 115, 120 can house at least two battery blocks 105 in a single plastic housing. The battery cells 110 can be positioned within the respective one of the cell holder 115, 120 using adhesive material (e.g., 2-part epoxy, silicone-based glue, or other liquid adhesive), heat staking, or press fit. The battery cells 110 can be positioned within the respective one of the cell holder 115, 120 to hold them in place. For example, the battery cells 110 can have a tolerance in height as part of the manufacturing process. This tolerance can be accounted for by locating either the top or bottom of the respective battery cells 110 to a common plane and fixing them there within the respective one of the cell holders 115, 120. For example, a bottom end of each of the battery cells 110 can be positioned flat relative to each other to provide a flat mating surface to a cold plate 130. The top end of the battery cells 110 can be positioned flat relative to the first cell holder 115 to provide or form a flat plane for forming battery cell to current collector connections (e.g., wirebonding, laser welding). The flat plane may only be provided on a top or bottom plane of the battery cells 110 because the cell holders 115, 120 can be retained in the respective battery module 100 using adhesive material (e.g., 2-part epoxy, silicone-based glue, or other liquid adhesive), bolts/fasteners, pressure sensitive adhesive (PSA) tape, or a combination of these materials. The structure of the battery module 100 that the cell holders 115, 120 are placed in or disposed in can include a stamped, bent, or formed metal housing or could be a plastic housing made by injection molding or another manufacturing method. The electrical connections between battery blocks 105 and battery modules 100 can use aluminum or copper busbars (stamped/cut metallic pieces in various shapes) with fasteners, wires and ribbons (aluminum, copper, or combination of the two), press fit studs and connectors with copper cables, or bent/formed/stamped copper or aluminum plates.

The cold plate 130 can provide active cooling to at least one surface of the battery module 100, the battery blocks 105, or the battery cells 110. For example, the cold plate 130 can be in contact with at least one surface of the battery module 100, the battery blocks 105, or the battery cells 110 to provide active cooling. The cold plate 130 can provide different levels of cooling or temperature control to different portions of the battery module 100, for example, through one or more cooling zones. For example, the cold plate 130 can provide a first level of cooling to a first portion of the battery module 100 and a second, different level of cooling to a second, different portion of the battery module 100. The different portions can include different battery blocks 105 or different groupings of battery blocks 105. The different portions can include different battery cells 110 or different groupings of battery cells 110. For example, the different portions can include different subsets or different groupings of battery cells 110 within a common battery block 105. A plurality of cold plates 130 can be provided within a battery pack or a battery module 100. Each of the cold plates 130 can couple with at least one surface (e.g., bottom surface) of at least one battery block 105 of the plurality of battery blocks 105 of the battery module 100. Each of the plurality of cold plates 130 can be individually coupled with the battery monitoring unit 140 to receive the same or different control signals. The cold plate 130 can include a single cooling plate or multiple cooling plates. For example, the number of cooling plates of the cold plate 130 can correspond to the number of battery blocks 105 of the battery module 100 (e.g., one cooling plate coupled with at least one battery block 105). The cooling plate or cooling plates forming the cooling system can be individually removable (from each other) and replaceable. The cold plate 130 can include conductive metal such as, but not limited to, aluminum or copper. For example, the cold plate can be formed as a stamped plate and include a 3000-series aluminum material or a 1000-series aluminum material. The cold plate 130 can be formed from a combination of two or more different plates that are coupled or otherwise joined together. For example, the cold plate 130 can be formed from a multiple different plates that are coupled together using an adhesive material, brazing techniques, or welding techniques. The cold plate 130 can be formed having multiple plates that are layered on top of each other, for example, to form a top layer or top surface and a bottom layer or bottom surface. The cold plate 130 can include an aluminum top layer or top surface coupled with a one or more bent copper tubes brazed, welded, or coupled with the aluminum top layer using adhesive material.

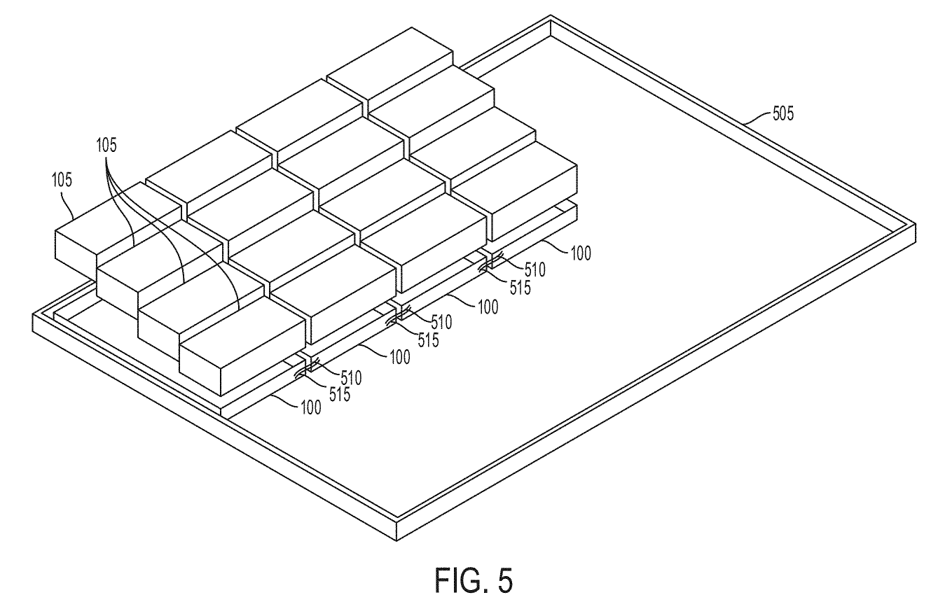

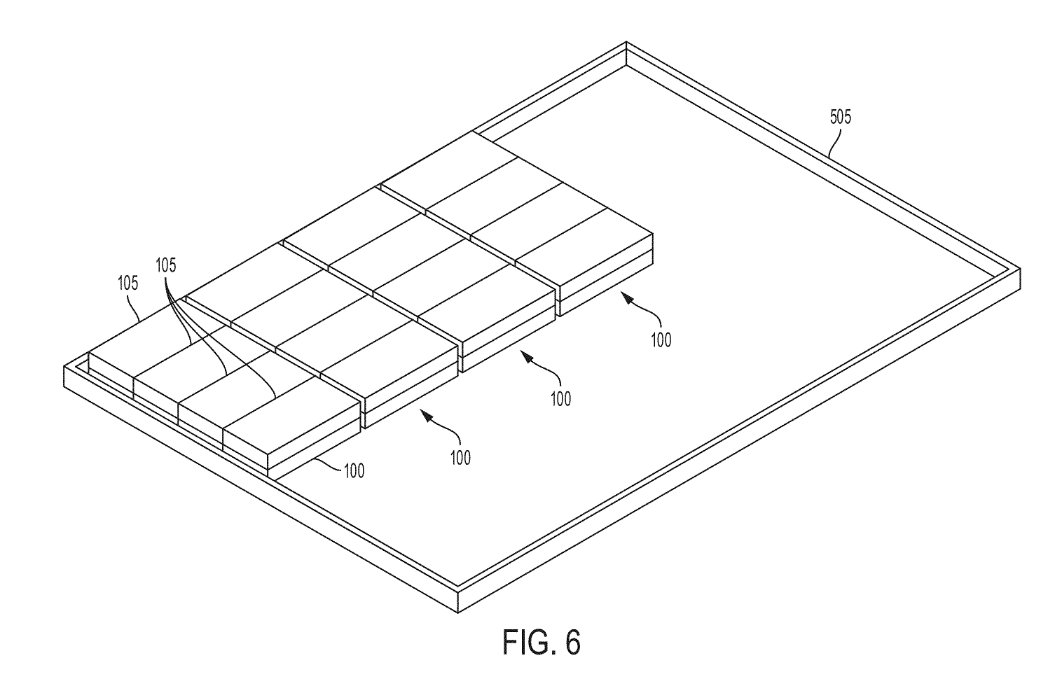

A battery monitoring unit 140 can couple with the battery module 100 or the cold plate 130 to provide system monitoring and controls to the battery module 100 and the cold plate 130. For example, the battery monitoring unit 140 with the battery module 100, one or more battery blocks 105, one or more battery cells 110 and one or more cold plates 130 through one or more BMU connectors 145. The BMU connectors 145, e.g., wires, wireless, or mechanical connectors, can include signal paths or conductive paths having at least one first end coupled with a port (e.g., input port, output port) of the battery monitoring unit 140 to receive signals from at least one component of the battery module 100 or to transmit signals to at least one component of the battery module 100. The BMU connectors 145 can include signal paths or conductive paths having at least one second end coupled with a port (e.g., input port, output port) of the battery module 100, one or more battery blocks 105, one or more battery cells 110 and one or more cold plates 130 to receive signals from the battery monitoring unit 140 or to transmit signals (e.g., voltage signals, current signals, temperature signals, power signals, status signals) from the respective component to the battery monitoring unit 140. The BMU connectors 145 can include wires or sense lines. The BMU connectors 145 can include conductive materials, such as but not limited to aluminum or copper. The battery monitoring unit 140 can monitor each of the battery blocks 105 forming the battery module 100 and each of the battery cells 110 forming the battery blocks 105. For example, the battery monitoring unit 140 can couple with outputs of the battery cells 110, outputs of the battery blocks 105, outputs of the battery modules or an output of a battery pack (e.g., battery pack 505 of FIGS. 5-6) to receive information, such as but not limited to current data, voltage data, or temperature data. Thus, the battery monitoring unit 140 can monitor and receive information and data from the battery pack, the battery modules 100, the battery blocks 105, or the battery cells 110. The battery monitoring unit 140 can generate control signals for the cold plate 130, the battery module 100, the battery blocks 105, or the battery cells 110. For example, responsive to receiving current data, voltage data, or temperature data, the battery monitoring unit 140 can generate control signals to modify a current level, voltage level, or temperature level of the respective the battery pack, the battery module 100, the battery blocks 105, or the battery cells 110 receiving the respective control signals. The battery monitoring unit 140 can generate control signals to maintain a current level, voltage level, or temperature level of multiple battery blocks 105 within a common battery module 100 such that the multiple battery blocks have the same current level, voltage level, or temperature level. The battery monitoring unit 140 can generate control signals to activate or deactivate (e.g., turn on, turn off) the cold plate 130, the battery pack, one or more battery modules 100, one or more battery blocks 105, or one or more battery cells 110 receiving the respective control signals.

The battery monitoring unit 140 can generate control signals for the cold plate 130 having one or more climate control parameters. The climate control parameters can be used to provide cooling at a predetermined cooling level, as indicated in the control signal, for the battery module 100, one or more battery blocks 105 of the battery module 100, or one or more battery cells 110 of the battery module 100, or to provide cooling at a predetermined cooling level, as indicated in the control signal, for portions of the battery module 100, one or more battery blocks 105 of the battery module 100, or one or more battery cells 110 of the battery module 100. The battery monitoring unit 140 can determine, according to the monitoring, to control the cold plate 130 coupled with the battery module 100 to control, regulate, or reduce the temperature within the battery module 100, within one or more battery blocks 105 forming the battery module 100, or for one or battery cells 110 forming the one or more battery blocks 105, for example. The battery monitoring unit 140 can control the cold plate 130 or other components of the corresponding battery module 100, such as one or more battery blocks 105 or one or more battery cells 110. For example, the battery monitoring unit 140 can monitor the cold plate 130, the battery module 100, one or more battery blocks 105, or one or more battery cells 110 and generate or report a status or provide local diagnostics of the corresponding cold plate 130, battery pack, battery module 100, battery block 105, or battery cell 110. The battery monitoring unit 140 can generate an alert or notification, for example, a notification for a user of the battery pack to indicate when a particular battery cell 110, battery block 105, battery module 100, or battery pack 505 should be repaired, replaced, or serviced.

The battery monitoring unit 140 can be coupled with at least one surface of the battery module 100, battery blocks 105, or cold plate 130 through BMU connectors 145. For example, the BMU connectors 145 can have at least one first end coupled with at least one port of the battery monitoring unit 140 and at least one second end coupled with a top surface, a side surface, or a bottom surface of the battery module 100, battery blocks 105, or cold plate 130. For example, the cold plate 130 can include a first side (e.g., top side, top end, top layer) that is coupled to the second side of the battery module 100 and a first side (e.g., top side, top end) of the battery monitoring unit 140 can be coupled with the second side of the cold plate 130 using at least one BMU connector 145 such that the cold plate 130 is disposed between the battery module 100 and the monitoring circuitry 140. The battery monitoring unit 140 can include a single battery monitoring unit 140 coupled with the cold plate 130 and each of the battery blocks 105 forming the battery module 100. The battery monitoring unit 140 can include multiple battery monitoring units 140, with each cold plate 130 coupled with at least one of the battery blocks 105 of the battery module 100 and coupled with the cold plate 130 or cooling systems 130.

The battery monitoring unit 140 can include a circuit board (e.g., printed circuit board) or circuit components coupled with, disposed on, or embedded in a non-conductive material or layer. For example, the battery monitoring unit 140 can include a processor or a microprocessor. The processor or microprocessor can include computing logic, one or more transistors for switching, an analog-to-digital converter (ADC) for analog to digital conversion, at least one power input, at least one digital communication port (CAN, SPI), and commands received from a master battery monitoring system. For example, the battery monitoring unit 140 of battery module 100 can couple with a battery pack monitoring system of a battery pack (e.g., battery pack 505) the respective battery module 100 is disposed within. Inputs to or otherwise received at the battery monitoring unit 140 can include voltage signals (e.g., voltage analog signals), current signals (e.g., current analog signals), and temperature signals (e.g., temperature analog signals). For example, the voltage can be measured at battery cell voltage terminals by welding physical electrical connections through BMU connectors 145 to at least one signal paths or at least one conductive path (e.g., conductive trace lines, sense lines, conductive patch). The corresponding voltage signals can be transmitted to the battery monitoring unit 140 through BMU connectors 145 coupled with one or more signal paths or conductive paths (e.g., conductive trace lines, sense lines) formed on or embedded within the battery module 100 (e.g., embedded within a first holder plate 115). The voltage signals can be transmitted through BMU connectors 145 coupled with one or more signal paths or conductive path as an analog measurement (e.g., voltage analog inputs) to the battery monitoring unit 140. The temperature can be measured at one or more points within a battery module 100, battery block 105, or battery cell 110. For example, the temperature can be measured at a hottest point of one or more battery cells 110 using a temperature sensor (e.g., thermistor) and the corresponding temperature signals can be transmitted to the battery monitoring unit 140 through BMU connectors 145 coupled with or including one or more signal paths or conductive paths (e.g., conductive trace lines, sense lines) formed on or embedded within the battery module 100 (e.g., embedded within a first holder plate 115). The temperature signals can be transmitted through one or more signal paths or conductive path as an analog measurement to the battery monitoring unit 140. The current can be measured using a current shunt on the battery monitoring unit 140.

The battery monitoring unit 140 of the battery module 100 can be removable from the battery module 100 or battery pack (e.g., battery pack 505 of FIG. 5) and replaceable by another monitoring circuitry 140. The battery monitoring unit 140 can be disconnected from the battery module 100 or battery pack and replaced with another battery monitoring unit 140 without impacting the operation of the battery module 100 or battery pack or modifying the arrangement of the battery cells 110, battery blocks 105, the battery modules 100 or battery pack. The battery monitoring unit 140 can be disconnected from the battery module 100 or battery pack and replaced with another battery monitoring unit 140 without damaging or modifying the battery module 100 or battery pack.

The battery module 100 can include a physical structure 160 to hold or couple multiple battery blocks 105 together. The physical structure 160 can be positioned and arranged to couple the cold plate 130 and the battery monitoring unit 140 with one or more battery blocks 105. The physical structure 160 can include a non-conductive layer or material formed around (e.g., enclosure) multiple battery blocks 105. The physical structure 160 can include a flexible material or strap disposed around the multiple battery blocks 105, cold plate 130, or monitoring circuitry 140.

There is an increasing demand for higher capacity battery cells 110 (e.g., 0-5V and 2-20 Ah) for high power, higher performance battery modules 100 or battery packs. Such battery modules 100 or battery packs can be used to support applications such as plug-in hybrid electrical vehicle (PHEV), hybrid electrical vehicle (HEV), or electrical vehicle (EV), automotive systems, among others. Increasing capacity or power of a battery module 100 or a battery pack by incorporating more battery blocks 105 or battery cells 110 (e.g., more components) can result in reduced reliability due to localized overheating or reliability issues. High power, high voltage battery packs are costly and do not have a long lifetime. For example, modules, battery cells, and cooling systems within conventional battery packs can be hard to service and difficult to replace or unreplaceable once installed, which prohibits rework and decreases yield rates during manufacturing, and also does not allow for maintenance and serviceability once in the field. Thus, the battery module 100 as described here can be packaged as its own modular system or unit, installed as one and can be fitted with quick disconnects or designed so that the corresponding battery module 100, battery blocks 105 forming the battery module 100, or the battery cells 110 forming the battery blocks 105 can be individually removed or replaced to meet and extend a lifetime of a battery pack (e.g., battery pack 505 of FIGS. 5-6). Each of the components of battery packs as described herein can be individually removable, replaceable, or serviceable. For example, the battery cells 110 can be individually removable, replaceable, or serviceable from a battery block 105. For example, each of the battery cells 110 can be individually replaceable from a battery block 105 and replaceable by another battery cell 110. The battery blocks 105 can be individually removable, replaceable, or serviceable from a battery module 100. For example, each of the battery blocks 105 can be individually replaceable from a battery module 100 and replaceable by another battery block 105. The battery modules 100 can be individually removable, replaceable, or serviceable from a battery pack 505. For example, each of the battery modules 100 can be individually replaceable from a battery pack 505 and replaceable by another module 100. The cold plate 130 can be individually removable, replaceable, or serviceable from a battery module 100 of a battery pack 505. For example, the cold plate 130 can be individually replaceable from the battery module 100 and replaceable by another cold plate 130. This can increase yield rates of battery packs, provide serviceability, and increase life and warranty of each battery pack, as individual components can be repaired or replaced without greatly impacting performance of the overall performance or output of the battery pack 505.

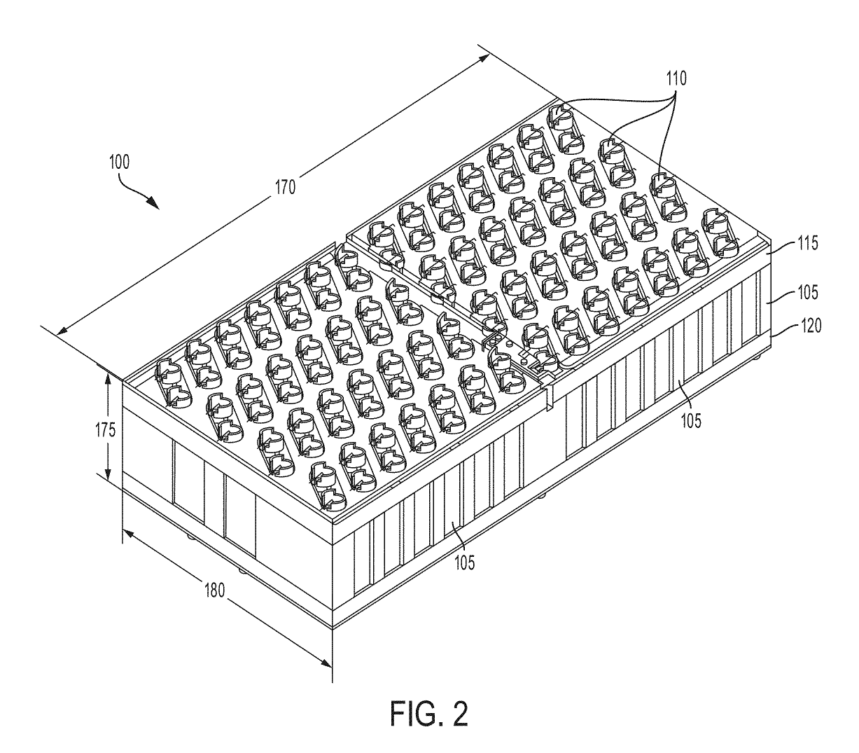

FIG. 2, among others, depicts an example system to power electric vehicles. A battery module 100 is provided having two battery blocks 105 (e.g., a first battery block 105 and a second battery block 105). The first and second battery blocks 105 can be subcomponents of the battery module 100. The number of battery blocks 105 in a battery module 100 can vary and can be selected based at least in part on an amount of energy or power to be provided to an electric vehicle. For example, the battery module 100 can couple with one or more bus-bars within a battery pack or couple with a battery pack of an electric vehicle to provide electrical power to other electrical components of the electric vehicle. The battery module 100 includes multiple battery blocks 105. The battery module 100 can include multiple cell holders 115, 120 to hold or couple the battery blocks 105 together, and to couple the battery cells 110 to form the battery blocks 105 together.

The first and second battery blocks 105 include a plurality of battery cells 110. The battery cells 110 can be homogeneous or heterogeneous in one or more aspects, such as height, shape, voltage, energy capacity, location of terminal(s) and so on. The first battery block 105 may include the same number of battery cells 110 as the second battery block, or the first battery block 105 may have a different number of battery cells 110 (e.g., greater than, less than) the second battery block 105. The first and second battery blocks 105 can include any number of battery cells 110 arranged in any configuration (e.g., an array of N×N or N×M battery cells, where N, M are integers). For example, a battery block 105 may include two battery cell 110 or fifty battery cells 110. The number of battery cells 110 included within a battery block 105 can vary within or outside this range. The number of battery cells 110 included within a battery block 105 can vary based in part on battery cell level specifications, battery module level requirements, battery pack level requirements or a combination of these that you are trying to obtain or reach with the respective battery block 105. The number of battery cells 110 to include in a particular battery block 105 can be determined based at least in part on a desired capacity of the battery block 105 or a particular application of the battery block 105. For example, a battery block 105 can contain a fixed “p” amount of battery cells, connected electrically in parallel which can provide a battery block capacity of “p” times that of the single battery cell capacity. The voltage of the respective battery block 105 (or cell block) can be the same as that of the single battery cell 110 (e.g., 0V to 5V or other ranges), which could be treated as larger cells that can be connected in series into the battery module 100 for battery packs for example. For example, the plurality of cylindrical battery cells 110 can provide a battery block capacity to store energy that is at least five times greater than a battery cell capacity of each of the plurality of cylindrical battery cells 110. The battery blocks 105 can have a voltage of up to 5 volts across the pair of battery block terminals of the respective battery block 105.

The battery blocks 105 can each include one or more battery cells 110 and each of the plurality of battery cells 110 can have a voltage of up to 5 volts (or other limit) across terminals of the corresponding battery cell. For example, the battery blocks 105 can include an arrangement of a plurality of battery cells 110 electrically connected in parallel. Each cell of the plurality of battery cells 110 can be spatially separated from each of at least one adjacent cell by, for example, two millimeter (mm) or less. The arrangement of the plurality of battery cells 110 can form a battery block 105 for storing energy and can have a voltage of up to 5 volts across terminals of the respective battery block 105.

For instance, a single battery cell 110 can have a maximum voltage of 4.2V, and the corresponding battery block 105 can have a maximum voltage of 4.2V. By way of an example, a battery block 105 using 5 volts/5 Ampere-hour (5V/5 Ah) cells with 60 cells in parallel can become a 0V to 5V, 300 Ah modular unit. The battery block 105 can have high packaging efficiency by utilizing a minimum cell to cell spacing (e.g., any value from 0.3 mm to 2 mm) that prevents thermal propagation within the block with each cell having an individual and isolated vent port for instance. For example, spatial separation between adjacent cells of less than 1 mm can be implemented in the present battery blocks 105. The battery block 105 can thus be small, e.g., less than 0.05 cubic feet, giving it a high volumetric energy density for high packing efficiency.

The battery block 105 can include battery cells 110 physically arranged in parallel to each other along the longest dimension of each battery cell 110. The battery cells 110 can be arranged physically as a two dimensional array of battery cells 110, or can be arranged physically as a three dimensional array of battery cells 110. For example, the battery cells 110 can be arranged in an array formation having three values, such as a length value 170, a height value (or depth value) 175, and a width value 180 to form the battery block 105 or battery module 100. As depicted in FIG. 2, the battery module 100 can have a dimension of length 170×width 180×height 175. The battery module 100 can have a length value 170 of 200 mm, a width value 180 of 650 mm, and a height value 175 of 100 mm. The length 170 may range from 25 mm to 700 mm. The width 180 may range from 25 mm to 700 mm. The height 175 (or depth) may range from 65 mm to 150 mm. The height 175 of the battery block 105 or battery module may correspond to (or be dictated by) the height or longest dimension of a component the battery cell 110.

The battery blocks 105 may form or include an enclosure or housing. For example, the plurality of battery cells 110 can be enclosed in a battery block enclosure. The battery block enclosure can be formed in a variety of different shapes, such as but not limited to, a rectangular shape, a square shape or a circular shape. The battery block enclosure can be formed having a tray like shape and can include a raised edge or border region. The battery cells 110 can be held in position by the raised edge or border region of the battery block enclosure. The battery block enclosure can be coupled with, in contact with, or disposed about the plurality of battery cells 110 to enclose the plurality of battery cells 110. For example, the battery block enclosure can be formed such that it at least partially surrounds or encloses each of the battery cells 110. The battery block enclosure can be less than 1 cubic feet in volume. For example, the battery block 105 enclosure can be less than 0.05 cubic feet in volume.

The battery cells 110 can be provided or disposed in the first and second battery blocks 105 and can be arranged in one or more rows and one or more columns of battery cells 110. Each of the rows or columns of battery cells 110 can include the same number of battery cells 110 or they can include a different number of battery cells 110. The battery cells 110 can be arranged spatially relative to one another to reduce overall volume of the battery block 105, to allow for minimum cell to cell spacing (e.g., without failure or degradation in performance), or to allow for an adequate number of vent ports. The rows of battery cells 110 can be arranged in a slanted, staggered or offset formation relative to one another. The battery cells 110 can be placed in various other formations or arrangements.

Each of the battery cells 110 in a common battery block 105 (e.g., same battery block 105) can be spaced from a neighboring or adjacent battery cell 110 in all directions by a distance that ranges from 0.5 mm to 3 mm (e.g., 1.5 mm spacing between each battery cell 110, 2 mm spacing between each battery cell 110). The battery cells 110 in a common battery block 105 can be uniformly or evenly spaced. For example, each of the battery cells 110 can be spaced the same distance from one or more other battery cells 110 in the battery blocks 105. One or more battery cells 110 in a common battery block 105 can be spaced one or more different distances from another one or more battery cells 110 of the common battery block 105. Adjacent battery cells 110 between different battery blocks 105 can be spaced a distance in a range from 2 mm to 6 mm. The distances between the battery cells 110 of different battery blocks 105 can vary across applications and configurations, and can be selected based at least in part on the dimensions of the battery blocks 105, electrical clearance or creepage specifications, or manufacturing tolerances for the respective battery module 100.

The battery block 105 can provide a battery block capacity of up to 300 Ampere-hour (Ah) or more. The battery block 105 can provide varying capacity values. For example, the battery block 105 can provide a capacity value that corresponds to a total number of cylindrical battery cells 110 in the plurality of cylindrical battery cells 110 forming the respective battery block 105. For example, the battery block 105 can provide a battery block capacity in a range from 8 Ah to 600 Ah. The battery block capacity can vary within or outside this range. The battery blocks 105 can be formed having a variety of different shapes. For example, the shape of the battery blocks 105 can be determined or selected to accommodate a battery module 100 or battery pack within which a respective battery block 105 is to be disposed. The shape of the battery blocks 105 may include, but not limited to, a square shape, rectangular shape, circular shape, or a triangular shape. Battery blocks 105 in a common battery module 100 can have the same shape or one or more battery blocks 105 in a common battery module 100 can have a different shape from one or more other battery blocks 105 in the common battery module 100.

The battery blocks 105 can each include at least one cell holder 115, 120 (sometimes referred as a cell holder). For example, the first and second battery blocks 105 can each include a first cell holder 115 and a second cell holder 120. The first cell holder 115 and the second cell holder 120 can house, support, hold, position, or arrange the battery cells 110 to form the first or second battery blocks 105 and may be referred to herein as structural layers. For example, the first cell holder 115 and the second cell holder 120 can hold the battery cells 110 in predetermined positions or in a predetermined arrangement to provide the above described spatial separation (e.g., spacing) between each of the battery cells 110. The first cell holder 115 can couple with or be disposed on or over a top surface of each of the battery cells 110. The second cell holder 120 can couple with or contact a bottom surface of the each of the battery cells 110.

The first cell holder 115 and the second cell holder 120 can include one or more recesses, cutouts or other forms of holes or apertures to hold portions of the battery cells 110. The recesses, cutouts or other forms of holes or apertures of the first and second cell holders 115, 120 can be formed to conform or match with, or correspond to the dimensions of the battery cells 110. For example, each of the recesses, cutouts or other forms of holes or apertures can have the same dimensions (e.g., same diameter, same width, same length) as each of the battery cells 110 to be disposed within the respective recess, cutout, or other forms of holes or apertures. The battery cells 110 can be disposed within the recesses, cutouts or other forms of holes or apertures such that they are flush with an inner surface of the recesses, cutouts or other forms of holes or apertures. For example, an outer surface of each of the battery cells 110 can be in contact with the inner surface of the recesses, cutouts or other forms of holes or apertures of each of the first and second cell holders 115, 120 when the battery cells 110 are disposed within or coupled with the recesses, cutouts or other forms of holes or apertures of each of the first and second cell holders 115, 120.

The battery module 100 can include a single battery block 105 or multiple battery blocks 105 (e.g., two battery blocks 105, or more than two battery blocks 105). The number of battery blocks 105 in a battery module 100 can be selected based at least in part on a desired capacity, configuration or rating (e.g., voltage, current) of the battery module 100 or a particular application of the battery module 100. For example, a battery module 100 can have a battery module capacity that is greater than the battery block capacity forming the respective battery module 100. The battery module 100 can have a battery module voltage greater than the voltage across the battery block terminals of the battery block 105 within the respective battery module 100. The battery blocks 105 can be positioned adjacent to each other, next to each other, stacked, or in contact with each other to form the battery module 100. For example, the battery blocks 105 can be positioned such that a side surface of the first battery block 105 is in contact with a side surface of the second battery block 105. The battery module 100 may include more than two battery blocks 105. For example, the first battery blocks 105 can have multiple side surfaces positioned adjacent to or in contact with multiple side surfaces of other battery blocks 105. Various types of connectors can couple the battery blocks 105 together within the battery module 100. The connectors may include, but not limited to, straps, wires, ribbonbonds, adhesive layers, or fasteners.

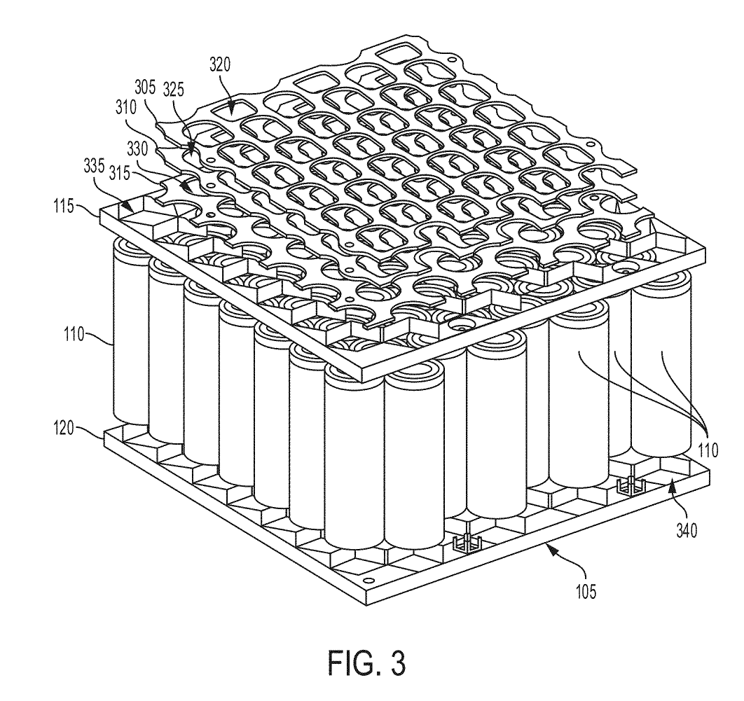

FIG. 3, among others, provides an exploded view of an example battery block 105. The first cell holder 115 or the second cell holder 120 can include a plurality of layers (e.g., conductive layers, non-conductive layers) that couple the plurality of battery cells 110 with each other. Each of the first cell holder 115 and the second cell holder 120 can include alternating or interleaving layers of conductive layers and non-conductive layers. For example, each of the first cell holder 115 and the second cell holder 120 may include a positive conductive layer, an isolation layer having a non-conductive material, and a negative conductive layer.

FIG. 3 includes an example view of different layers of the first cell holder 115. In particular, FIG. 3 shows a second surface (e.g., bottom surface) of a first conductive layer 305 disposed over, coupled with, or in contact with a first surface (e.g., top surface) of a non-conductive layer 310. A second surface (e.g., bottom surface) of the non-conductive layer 310 is disposed over, coupled with, or in contact with a first surface (e.g., top surface) of a second conductive layer 315. A second surface (e.g., bottom surface) of the second conductive layer 315 is disposed over, coupled with, or in contact with a first surface (e.g., top surface) of the first cell holder 115. The first cell holder 115 can hold, house or align the first conductive layer 305, the non-conductive layer 310, and the second conductive layer 315. For example, the first cell holder 115 can include a border or raised edge formed around a border of the first cell holder 115 such that the first conductive layer 305, the non-conductive layer 310, and the second conductive layer 315 can be disposed within the border or raised edge. The border or raised edge formed around a border of the first cell holder 115 can hold the first conductive layer 305, the non-conductive layer 310, and the second conductive layer 315 in place and in physical contact with each other.

The first conductive layer 305, the non-conductive layer 310, the second conductive layer 315, the first cell holder 115, and the second cell holder 120 can include a plurality of apertures. The number of apertures can be selected based in part on the size and dimensions of the first conductive layer 305, the non-conductive layer 310, the second conductive layer 315, the first cell holder 115, the second cell holder 120, and the battery cells 110. For example, the first conductive layer 305 can include a first plurality of apertures 320 having a first shape. The non-conductive layer 310 can include a second plurality of apertures 325 having a second shape. The second conductive layer 315 can include a third plurality of apertures 330 having a third shape. The first cell holder 115 can include a fourth plurality of apertures 335 having a fourth shape. The second cell holder 120 can include a fifth plurality of apertures 340 having a fifth shape. The apertures 320, 325, 330, 335, 340 can include an opening or hole formed through each of the respective layers, or a recess formed into the respective layers or structures.

The shape, dimensions, or geometry of one or more of the first plurality of apertures 320, the second plurality of apertures 325, the third plurality of apertures 330, the fourth plurality of apertures 335, and the fifth plurality of apertures 340 can be different. The shape, dimensions, or geometry of one or more of the first plurality of apertures 320, the second plurality of apertures 325, the third plurality of apertures 330, the fourth plurality of apertures 335, and the fifth plurality of apertures 340 can be the same or similar. The shape, dimensions, or geometry of the apertures 320, 325, 330, 335, 340 can be selected according to an arrangement or separation of the battery cells 110. Two or more of the first, second, third, fourth and fifth shapes can be conformed at least in part relative to one other. Two or more of the first, second, third, fourth and fifth pluralities of apertures can be aligned relative to one other. The shape, dimensions, or geometry of the apertures 320, 325, 330, 335, 340 can be determined based at least in part on the shape, dimensions, or geometry of the battery cells 110. For example, the plurality of battery cells 110 can be disposed or positioned between a second surface (e.g., bottom surface) of the first cell holder 115 and a first surface (e.g., top surface) of the second cell holder 120. The first cell holder 115 or the second cell holder 120 can hold, house or align the plurality of battery cells 110 using the fourth plurality of apertures 335 or the fifth plurality of apertures 340, respectively. For example, each of the battery cells 110 can be disposed within the battery block 105 such that a bottom end or bottom portion of a battery cell 110 is disposed in, coupled with or on contact with at least (an edge, boundary, side, surface or structure of) one aperture of the fifth plurality of apertures 340 formed in the second cell holder 120, and a top end or top portion of a battery cell 110 is disposed in, coupled with or on contact with at least one (an edge, boundary, side, surface or structure of) aperture of the fourth plurality of apertures 335 formed in the first cell holder 115.

The apertures 320, 325, 330 of the first conductive layer 305, the non-conductive layer 310, and the second conductive layer 315 can allow a connection to a positive layer (e.g., first conductive layer 305) or negative layer (e.g., second conductive layer 315) from each of the battery cells 110. For example, a wirebond can extend through the apertures 320, 325, 330 to couple a positive terminal or surface of a battery cell with the first conductive layer 305. Thus, the apertures 320, 325, 330 can be sized to have a diameter or opening that is greater than a diameter or cross-sectional shape of the wirebond. A negative tab can extend from the second conductive layer 315 and be connected to a negative surface or terminal on at least two battery cells 110. For example, a wirebond can extend from the negative tab to couple with a portion of a negative terminal on a battery cell 110 that is exposed by the aperture 330. Thus, one or more apertures 320, 325, 330 can be sized to have dimensions that are greater than the dimensions of the negative tab. The shape of the apertures 320, 325, 330, 335, 340 can include a round, rectangular, square, or octagon shape or form as some examples. The dimensions of the apertures 320, 325, 330, 335, 340 can include a width of 21 mm or less for instance. The dimensions of one or more of the apertures 320, 325, 330, 335, 340 can be 12 mm in width and 30 mm in length for example.

The apertures 320, 325, 330 can be formed such that they are smaller than the apertures 335, 340. For example, the apertures 335 and 340 can have a diameter in a range from 10 mm to 35 mm (e.g., 18 mm to 22 mm). The apertures 320, 325, 330 can have a diameter in a range from 3 mm to 33 mm. If the apertures 335, 340 are formed having a square or rectangular shape, the apertures 335, 340 can have a length in a range from 4 mm to 25 mm (e.g., 10 mm). If the apertures 335, 340 are formed having a square or rectangular shape, the apertures 335, 340 can have a width in a range from 4 mm to 25 mm (e.g., 10 mm). For example, the apertures 335, 340 can have dimensions of 10 mm×10 mm. If the apertures 320, 325, 330 are formed having a square or rectangular shape, the apertures 320, 325, 330 can have a length in a range from 2 mm to 20 mm (e.g., 7 mm). If the apertures 320, 325, 330 are formed having a square or rectangular shape, the apertures 320, 325, 330 can have a width in a range from 2 mm to 20 mm (e.g., 7 mm). For example, the apertures 320, 325, 330 can have dimensions of 7 mm×7 mm.

Apertures 325 can be formed such that they are smaller (e.g., have smaller dimensions) or offset with respect to apertures 320. For example, apertures 325 can correspond to apertures 320, such as having the same geometric shape with just an offset to make the apertures 325 smaller with respect to apertures 320. For example, the offset can be in a range from 0.1 mm to 6 mm depending on isolation, creepage, and clearance requirements. Apertures 325 can be sized the same as or identical to aperture 320.

The apertures 320, 325, 330 can be formed in a variety of shapes. For example, the apertures 320, 325, 330 may not be formed as distinct patterned openings or formed having distinct patterned openings. For example, the apertures 320, 325, 330 can be formed as a geometric cut from the sides of the respective one of layers 305, 310, 315. The apertures 320, 325, 330 can be formed as half circular cutouts around the perimeter of each of the respective one of layers 305, 310, 315, respectively.

The first conductive layer 305 and the second conductive layer 315 can include a conductive material, a metal (e.g., copper, aluminum), or a metallic material. The first conductive layer 305 can be a positive conductive layer or positively charged layer. The second conductive layer 315 can be a negative conductive layer or negatively charged layer. The first conductive layer 305 and the second conductive layer 315 can have a thickness in a range of 0.1 mm to 8 mm for example. The first conductive layer 305 and the second conductive layer 315 can have a thickness in a range of 1 to 8 millimeters (e.g., 1.5 mm). The first conductive layer 305 and the second conductive layer 315 can have the same length as battery block 105. For example, the first conductive layer 305 can have a length in a range from 25 mm to 700 mm (e.g., 150 mm). The first conductive layer 305 and the second conductive layer 315 can have the same width as battery block 105. For example, the first conductive layer 305 can have a width in a range from 25 mm to 700 mm (e.g., 330 mm).

The non-conductive layer 310 can include insulation material, plastic material, epoxy material, FR-4 material, polypropylene materials, or formex materials. The non-conductive layer 310 can hold or bind the first conductive layer 305 and the second conductive layer 315 together. The non-conductive layer 310 can include or use adhesive(s) or other binding material(s) or mechanism(s) to hold or bind the first conductive layer 305 and the second conductive layer 315 together. The non-conductive layer 310, the first conductive layer 305, and the second conductive layer 315 can be held or bound together to form a multi-layer composite, sometimes collectively referred as a multi-layered current collector. The dimensions or geometry of the non-conductive layer 310 can be selected to provide a predetermined creepage, clearance or spacing (sometimes referred to as creepage-clearance specification or requirement) between the first conductive layer 305 and the second conductive layer 315. For example, a thickness or width of the non-conductive layer 310 can be selected such that the first conductive layer 305 is spaced at least 3 mm from the second conductive layer 315 when the non-conductive layer 310 is disposed between the first conductive layer 305 and the second conductive layer 315. The non-conductive layer 310 can be formed having a shape or geometry that provides the predetermined creepage, clearance or spacing. For example, the non-conductive layer 310 can have a different dimension than that the first conductive layer 305 and the second conductive layer 315, such that an end or edge portion of the non-conductive layer 310 extends out farther (e.g., longer) than an end or edge portion of the first conductive layer 305 and the second conductive layer 315 relative to a horizontal plane or a vertical plane. The distance that an end or edge portion of the non-conductive layer 310 extends out can provide the predetermined creepage, clearance or spacing (e.g., 3 mm creepage or clearance). The thickness and insulating structure of the non-conductive layer 310, first conductive layer 305, and the second conductive layer 315, can provide the predetermined creepage, clearance or spacing. The thickness and insulating structure of the non-conductive layer 310, that separate the first conductive layer 305 from the second conductive layer 315, can provide the predetermined creepage, clearance or spacing. Thus, the dimensions of the non-conductive layer 310 can be selected, based in part, to meet creepage-clearance specifications or requirements. The dimensions of the non-conductive layer 310 can reduce or eliminate arcing between the first conductive layer 305 and the second conductive layer 315. The non-conductive layer 310 can have a thickness that ranges from 0.1 mm to 8 mm (e.g., 1 mm). The non-conductive layer 310 can have the same width as the battery block 105. For example, the non-conductive layer 310 can have a width in a range from 25 mm to 700 mm (e.g., 330 mm). The non-conductive layer 310 can have the same length as the battery block 105. For example, the non-conductive layer 310 can have a length in a range from 25 mm to 700 mm (e.g., 150 mm).

The first cell holder 115 and the second cell holder 120 can include plastic material, acrylonitrile butadiene styrene (ABS) material, polycarbonate material, or nylon material (e.g., PA66 nylon) with glass fill for instance. The rigidity of first cell holder 115 and the second cell holder 120 can correspond to the material properties forming the respective first cell holder 115 and the second cell holder 120, such as flexural modulus. The first cell holder 115 and the second cell holder 120 can have a dielectric strength of 300V/mil for instance (other values or ranges of the values are possible). The first cell holder 115 and the second cell holder 120 can for example have a tensile strength of 9,000 psi (other values or ranges of the values are possible. The first cell holder 115 and the second cell holder 120 can have a flexural modulus (e.g., stiffness/flexibility) of 400,000 psi (other values or ranges of the values are possible). The values for the dielectric strength, tensile strength, or flexural modulus can vary outside these values or range of values and can be selected based in part on a particular application of the first cell holder 115 and the second cell holder 120. The first cell holder 115 and the second cell holder 120 can have a flame resistance rating (e.g., FR rating) of UL 94 rating of V-0 or greater.

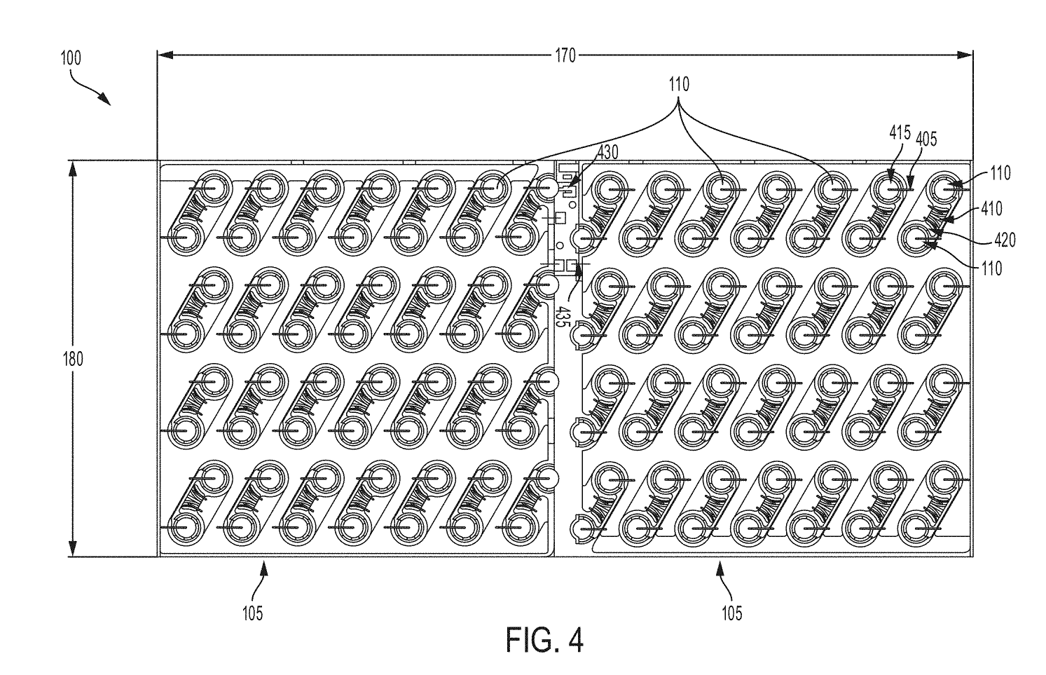

FIG. 4 depicts a top view of the battery module 100 illustrating an example arrangement of the battery cells 110 in each of the first battery block 105 and the second battery block 105. The battery blocks 105 can include a pair of terminals 430, 435. For example, the battery blocks 105 include a first battery block terminal 430 and a second battery block terminal 435. The first battery block terminal 430 can correspond to a positive terminal and the second battery block terminal 435 can correspond to a negative terminal The plurality of cylindrical battery cells 110 can provide a battery block capacity to store energy that is at least five times greater than a battery cell capacity of each of the plurality of cylindrical battery cells 110. The battery blocks 105 can have a voltage of up to 5 volts across the pair of battery block terminals 430, 435. For example, the first battery block terminal 430 can be coupled with 5 V and the second battery block terminal 435 can be coupled with 0 v. The first battery block terminal 430 can be coupled with +2.5 V and the second battery block terminal 435 can be coupled with −2.5 V. Thus, a difference in voltage between the first battery block terminal 430 and the second battery block terminal 435 can be 5 V or up to 5 V.

The battery cells 110 in the first and second battery blocks 105 can be arranged in one or more rows and one or more columns of battery cells 110. The individual battery cells 110 can be cylindrical cells or other types of cells. Depending on the shape of each battery cell 110, the battery cells 110 can be arranged spatially relative to one another to reduce overall volume of the battery block 105, to minimize cell to cell spacing (e.g., without failure or degradation in performance), or to allow for an adequate number of vent ports. For instance, FIG. 4, among others, shows each row of battery cells 110 arranged in a slanted or offset formation relative to one another. The battery cells 110 can be placed in various other formations or arrangements.

Each of the battery cells 110 in a common battery block 105 (e.g., same battery block 105) can be spaced from a neighboring or adjacent battery cell 110 in all directions by a distance that ranges from 0.5 mm to 3 mm (e.g., 1.5 mm spacing between each battery cell 110, 2 mm spacing between each battery cell 110). For example, a first battery cell 110 can be spaced a distance of 1.5 mm from a neighboring second battery cell 110 and spaced a distance of 1.5 mm from a neighboring third battery cell 110. The battery cells 110 in a common battery block 105 can be uniformly spaced, or evenly spaced. One or more battery cells 110 in a common battery block 105 can be spaced one or more different distances from another one or more battery cells 110 of the common battery block 105.

The battery cells 110 (e.g., adjacent battery cells 110) between different battery blocks 105 (e.g., adjacent battery blocks) can be spaced a distance in a range from 2 mm to 6 mm. For example, one or more battery cells 110 disposed along an edge of a first battery block 105 can be spaced a distance in a range from 0 mm to 1 mm (e.g., 0.5 mm) from the edge of the first battery block 105 and one or more battery cells 110 disposed along an edge of a second battery block 105 can be spaced a distance in a range from 0 mm to 1 mm (e.g., 0.5 mm) from the edge of the second battery block 105. The edges of the first and second battery blocks 105 can be coupled with each other, in contact with each other, or facing each other such that the one or more battery cells 110 disposed along the edge of the first battery block 105 are spaced from the one or more battery cells 110 disposed along the edge of the second battery block 105 a distance in a range from 2 mm to 6 mm (e.g., 4.5 mm). The distances between the battery cells 110 of different battery blocks 105 can vary and can be selected based at least in part on the dimensions of the battery blocks 105, electrical clearance or creepage specifications, or manufacturing tolerances for the respective battery module 100. For example, battery cells 110 can be spaced a distance from a second, different battery cell 110 based on predetermined manufacturing tolerances that may control or restrict how close battery cells 110 can be positioned with respect to each other.

The battery cells 110 can each couple with a first layer (e.g., positive conductive layer) of the first cell holder 115. For example, the first cell holder 115 can include multiple layers, such as, a first layer forming a positive current collector (e.g., conductive positive layer 305 of FIG. 3), an isolation layer having non-conductive material, and a second layer forming negative current collector (e.g., conductive negative layer 315 of FIG. 3). Each of the battery cells 110 can include a pair of terminals 415, 420. For example, the battery cells 110 can include a positive terminal 415 and a negative terminal 420. The pair of terminals 415, 420 of each of the battery cells 110 can have up to 5 V across their respective terminals. For example, the positive terminal 415 can be coupled with +5 V and the negative terminal 420 can be coupled with 0 V. The positive terminal 415 can be coupled with +2.5 V and the negative terminal 420 can be coupled with −2.5 V. Thus, the difference in voltage between the positive terminal 415 and the negative terminal 420 of each battery cell 110 can be 5 v or in any value up to and including 5 V.

The positive terminal 415 of a battery cell 110 can be connected using a wirebond 405 or otherwise, with the first layer of the first cell holder 115. The negative terminal 420 or negative surface of a battery cell 110 can connect with the second layer of the first cell holder 115 through the negative tab 410. The positive terminal 415 and the negative terminal 420 of a battery cell 110 can be formed on or coupled with at least a portion of the same surface (or end) of the respective battery cell 110. For example, the positive terminal 415 can be formed on or coupled with a first surface (e.g., top surface, side surface, bottom surface) of the battery cell 110 and the negative terminal 420 of the battery cell 110 can be formed on or coupled with the same first surface. Thus, the connections to positive and negative bus-bars or current collectors can be made from the same surface (or end) of the battery cell 110 to simplify the installation and connection of the battery cell 110 within a battery block 105.

The negative tab 410 can couple at least two battery cells 110 with a conductive negative layer (e.g., conductive negative layer 315 of FIG. 3) of the first cell holder 115. The negative tab 410 can be part of the conductive negative layer, for example formed as an extension or structural feature within a plane of the conductive negative layer, or partially extending beyond the plane. The negative tab 410 can include conductive material, such as but not limited to, metal (e.g., copper, aluminum), or a metallic alloy or material. The negative tab 410 can form or provide a contact point to couple a battery cell 110 to a negative current collector of the first cell holder 115. The negative tab 410 can couple with or contact a top portion or top surface (e.g., negative terminal 420) of the battery cell 110. The negative tab 410 can couple with or contact a side surface of a battery cell 110. The negative tab 410 can couple with or contact a bottom portion or bottom surface of a battery cell 110. The surface or portion of a battery cell 110 the negative tab 410 couples with or contacts can correspond to the placement of the first cell holder 115 relative to the battery cell 110.

The negative tab 410 can couple with or contact surfaces of at least two battery cells 110. The negative tab 410 can be formed in a variety of different shapes and have a variety of different dimensions (e.g., conformed to the dimensions of the battery cells 110 and their relative positions). The shape of the negative tab 410 can include, but not limited to, rectangular, square, triangular, octagon, circular shape or form, or one or more combinations of rectangular, square, triangular, or circular shape or form. For example, the negative tab 410 can be formed having one or more sides (e.g., portions or edges) having a circular or curved shape or form to contact a surface of the battery cells and one or more sides having a straight or angled shape. The particular shape, form or dimensions of the negative tab 410 can be selected based at least in part on a shape, form or dimensions of the battery cells 110 or a shape, form or dimensions of the first cell holder 115. The shape and structure of the negative tab 410 can be formed in two or three dimensions. For example, one or more edges or portions of the negative tab 410 can be folded or formed into a shape or structure suitable for bonding to a negative terminal portion of a battery cell 110. For a two-dimensional negative tab 410 (e.g., a negative tab 410 with a thickness conformed with a thickness of the corresponding conductive negative layer), the negative tab 410 can include or be described with one or more parameters, such as length, a width, surface area, and radius of curvature. For a three-dimensional negative tab 410 (e.g., a negative tab 410 with at least a portion that does not conform with a thickness of the corresponding conductive negative layer), the negative tab 410 can include or be described with one or more parameters, including length, width, height (or depth, thickness), one or more surface areas, volume, and radius of curvature. The three-dimensional negative tab 410 can include a folded, curved or accentuated portion that provides a larger surface for a negative surface of a battery cell 110 to couple with or contact. For example, the three-dimensional negative tab 410 can have a greater thickness than a two-dimensional negative tab 410.

The wirebond 405 can be a positive wirebond 405 that can couple at least one battery cell 110 with a conductive positive layer (e.g., conductive positive layer 305 of FIG. 3) of the cell holder 115. The wirebond 405 can be formed in a variety of different shapes and have a variety of different dimensions. The particular shape or dimensions of wirebond 405 can be selected based at least in part on a shape or a dimension of the battery cells 110 or a shape or a dimension of the first cell holder 115. For example, the wirebond 405 can be sized to extend from a top surface, side surface or bottom surface of a battery cell 110. As depicted in FIG. 4, the wirebond 405 can extend from a top surface (e.g., a positive terminal 415) of a battery cell 110 and extend through apertures formed in each of the different layers forming the first cell holder 115, to contact a top surface of the conductive positive layer (e.g., conductive positive layer 305 of FIG. 3) of the cell holder 115. The shape of the wirebond 405 can be selected or implemented so as not to contact a negative layer of the first cell holder 115 as the wirebond 405 extends through the different layers forming the first cell holder 115. The shape or form of the wirebond 405 can include a rectangular shape, cylindrical shape, tubular shape, spherical shape, ribbon or tape shape, curved shape, flexible or winding shape, or elongated shape. The wirebond 405 can include electrical conductive material, such as but not limited to, copper, aluminum, metal, or metallic alloy or material.

FIGS. 5-6, among others, depicts a battery pack 505 having a plurality of battery modules 100, with each of the battery modules 100 having a plurality of battery blocks 105. The battery blocks 105 may include a plurality of battery cells 110. Each battery module 100 can include a physical structure 160 or holder to support, hold or partially enclose the corresponding battery blocks 105, cold plate 130, or battery monitoring unit 140 of the respective battery module 100. A battery pack 505 as described herein can refer to a battery system having multiple battery modules 100 (e.g., two or more). Multiple battery modules 100 can be electrically coupled with each other to form a battery pack 505, using one or more electrical connectors such as bus-bars. For example, battery blocks 105 can be electrically coupled or connected to one or more other battery blocks 105 to form a battery module 100 or battery pack 505 of a specified capacity and voltage. The number of battery blocks 105 in a single battery module 100 can vary and can be selected based at least in part on a desired capacity of the respective battery module 100. Each of the battery modules 100 can include a pair of terminals 510, 515. For example, the battery modules 100 can include a positive terminal 510 and a negative terminal 515. The pair of terminals 510, 515 of each of the battery modules 100 can have a voltage across the respective pair of battery module terminals 510, 515 that is greater than the voltage across each pair of battery block terminals 430, 435 or greater than the voltage across each pair of battery cell terminals 415, 420.

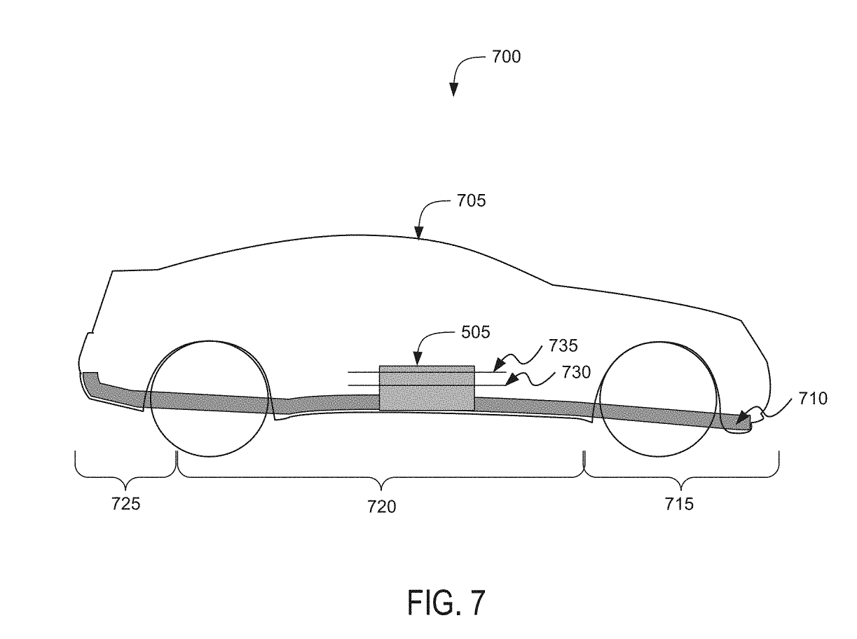

The number of battery modules 100 in a single battery pack 505 can vary and can be selected based at least in part on a desired capacity (e.g., battery pack capacity) of the respective battery pack 505 or a desired voltage (e.g., battery pack voltage) of the respective battery pack 505. For example, the number of battery modules 100 in a battery pack 505 can vary and can be selected based at least in part on an amount of energy to be provided to an electric vehicle. The battery pack 505 can couple or connect with one or more bus-bars of a drive train system of an electric vehicle to provide electrical power to other electrical components of the electric vehicle (e.g., as depicted in FIG. 7).

The battery blocks 105 and the battery modules 100 can be combinable with one or more other battery blocks 105 and battery modules 100 to form the battery pack 505 of a specified capacity and a specified voltage that is greater than that across the terminals of the battery block 105 or battery module 100. For instance, a high-torque motor may be suitably powered by a battery pack 505 formed with multiple battery cells (e.g., 500 cells), blocks 105 or modules 100 connected in parallel to increase capacity and to increase current values (e.g., in Amperes or amps) that can be discharged. A battery block 105 can be formed with 20 to 50 battery cells 110 for instance, and can provide a corresponding number of times the capacity of a single battery cell 110. A battery pack 505 formed using at least some battery blocks 105 or battery modules 100 connected in parallel can provide a voltage that is greater than that across the terminals of each battery block 105 or battery module 100. A battery pack 505 can include any number of battery cells 110 by including various configurations of battery blocks 105 and battery modules 100.

The battery module 100 or battery pack 505 having one or more battery blocks 105 can provide flexibility in the design of the battery module 100 or the battery pack 505 with initially unknown space constraints and changing performance targets. For example, standardizing and using small battery blocks 105 can decrease the number of parts (e.g., as compared with using individual cells) which can decrease costs for manufacturing and assembly. The battery modules 100 or battery packs 505 having one or more battery blocks 105 as disclosed herein can provide a physically smaller, modular, stable, high capacity or high power device that is not available in today's market, and can be an ideal power source that can be packaged into various applications.

The shape and dimensions of the battery pack 505 can be selected to accommodate installation within an electric vehicle. For example, the battery pack 505 can be shaped and sized to couple with one or more bus-bars of a drive train system (which includes at least part of an electrical system) of an electric vehicle. The battery pack 505 can have a rectangular shape, square shape, or a circular shape, among other possible shapes or forms. The battery pack 505 (e.g., an enclosure or outer casing of the battery pack 505) can shaped to hold or position the battery modules 100 within a drive train system of an electric vehicle. For example, the battery pack 505 can be formed having a tray like shape and can include a raised edge or border region. Multiple battery modules 100 can be disposed within the battery pack 505 can be held in position by the raised edge or border region of the battery pack 505. The battery pack 505 may couple with or contact a bottom surface or a top surface of the battery modules 100. The battery pack 505 can include a plurality of connectors to couple the battery modules 100 together within the battery pack 505. The connections may include, but not limited to, straps, wires, adhesive materials, or fasteners.

The battery blocks 105 can be coupled with each other to form a battery module 100 and multiple battery modules 100 can be coupled with each other to form a battery pack 505. The number of battery blocks 105 in a single battery module 100 can vary and be selected based at least in part on a desired capacity or voltage of the respective battery module 100. The number of battery modules 100 in a single battery pack 505 can vary and be selected based at least in part on a desired capacity of the respective battery pack 505. For instance, a high-torque motor may be suitably powered by a battery pack 505 having multiple battery modules 100, the battery modules 100 having multiple battery blocks 105 and the battery blocks 105 having multiple battery cells 110. Thus, a battery pack 505 can be formed with a total number of battery cells ranging from 400 to 600 (e.g., 500 battery cells 110), with the battery blocks 105 or battery modules 100 connected in parallel to increase capacity and to increase current values (e.g., in Amperes or amps) that can be discharged. A battery block 105 can be formed with any number of battery cells 110 and can provide a corresponding number of times the capacity of a single battery cell 110.

For example, a single battery block 105 can include a fixed number of battery cells 110 wired in parallel (“p” count) and have the same voltage with that of the battery cell 110, and “p” times the discharge amps. A single battery block 105 can be wired in parallel with one or more battery blocks 105 to make a larger “p” battery block 105 for higher current applications, or wired in series as a module/unit to increase voltage. Additionally, a battery block 105 can be packaged into varying applications and can meet various standard battery sizes as defined by regulating bodies (e.g., Society of Automotive Engineers (SAE), United Nations Economic Commission for Europe (UNECE), German Institute for Standardization (DIN)) for different industries, countries, or applications.

A battery block 105 that is standardized or modularized into a building block or unit, can be combined or arranged with other battery blocks 105 to form a battery module 100 (or battery pack 505) that can power any device or application, e.g., PHEV, REV, EV, automotive, low voltage 12 volt system, 24 volt system, or 48 volt system, 400 volt system, 800 volt system, 1 kilovolt system, motorcycle/small light duty applications, enterprise (e.g., large or commercial) energy storage solutions, or residential (e.g., small or home) storage solutions, among others.

In accordance with the concepts disclosed herein, battery components can be standardized or modularized at the battery block level rather than at the battery module level. For example, each of the battery cells 110 can be formed having the same shape and dimensions. Each of the battery blocks 105 can be formed having the same shape and dimensions. Each of the battery modules 100 can be formed having the same or different shape and dimensions. Thus, battery cells 110 can be individually replaced or additional battery cells 110 can be added to increase the capacity of the respective battery block 105. Battery blocks 105 can be individually replaced or additional battery blocks 105 can be added to increase the capacity of the respective battery module 100. For example, the plurality battery modules can have a battery module capacity that are greater than the battery block capacity. Each of the plurality of battery modules can have a battery module voltage greater than the voltage across the battery block terminals of the first battery block. Battery modules 100 can be individually replaced or additional battery modules 100 can be added to increase the capacity (e.g., battery pack capacity) of the respective battery pack 505 or a battery pack voltage of the battery pack 505. In some applications or embodiments, standardization or modularization at the battery module level can be implemented instead of, or in addition to that at the battery block level.

For example, consider the above example of a 5V/300 Ah battery block. For comparative purposes, current single battery cells of 5V/50 Ah technologies can be 0.03 cubic feet and six of these single cell batteries connected in parallel would make this 0.18 cubic feet in size. This is multiple times larger than a corresponding battery block disclosed herein (e.g., 0.05 cubic feet). Thus, other single cell technologies offer no volumetric advantage, and instead provide an increased hazard or failure risk.

The battery modules 100 or battery block 105 disclosed herein can overcome packaging constraints, and can meet various performance targets using the same voltage of each component battery cell (0-5V) but with “p” times the discharge amps (e.g., discharge amps multiplied by the number of cells connected in parallel in the battery block). The battery modules 100 or battery block 105 can be formed into battery packs 505 of various size, power and energy to meet different product performance requirements with the best packing efficiency and volumetric energy density that matches a specific design.

A battery block 105 can allow flexibility in the design of a battery module or a battery pack 505 with initially unknown space constraints and changing performance targets. Standardizing and using battery blocks (which are each smaller in size than a battery module) can decrease the number of parts (e.g., as compared with using individual cells) which can decrease costs for manufacturing and assembly. A standardized battery module, on the other hand, can limit the types of applications it can support due to its comparatively larger size and higher voltage. Standardizing battery modules 100 with nonstandard blocks 105 can increase the number of parts which can increase costs for manufacturing and assembly. In comparison, a battery block 105 as disclosed herein can provide a modular, stable, high capacity or high power device, such as a battery module 100 or battery pack 505, that is not available in today's market, and can be an ideal power source that can be packaged into various applications. Each component of the battery module 100 can be individually removable, replaceable, or serviceable. For instance, battery cells 110, battery blocks 105, cooling systems 130, or battery monitoring unit 140 can be individually removed from the battery module 100 or the battery pack 505, and can be removed from each other.

FIG. 7 depicts a cross-section view 700 of an electric vehicle 705 installed with a battery pack 505. The battery pack 505 can include at least one battery module 100 having at least one cold plate 130 and at least one battery monitoring unit 140. For example, the battery monitoring unit 140 can couple with outputs of battery blocks 105 or battery cells 110 forming the battery module 100 to monitor the battery blocks 105 or battery cells 110 forming the battery module 100 and generate control signals for the cold plate 130 to provide cooling to the battery blocks 105 or battery cells 110 forming the battery module 100. The electric vehicle 705 can include an autonomous, semi-autonomous, or non-autonomous human operated vehicle. The electric vehicle 705 can include a hybrid vehicle that operates from on-board electric sources and from gasoline or other power sources. The electric vehicle 705 can include automobiles, cars, trucks, passenger vehicles, industrial vehicles, motorcycles, and other transport vehicles. The electric vehicle 705 can include a chassis 710 (e.g., a frame, internal frame, or support structure). The chassis 710 can support various components of the electric vehicle 705. The chassis 710 can span or otherwise include a front portion 715 (e.g., a hood or bonnet portion), a body portion 720, and a rear portion 725 (e.g., a trunk portion) of the electric vehicle 705. The front portion 715 can include the portion of the electric vehicle 705 from the front bumper to the front wheel well of the electric vehicle 705. The body portion 720 can include the portion of the electric vehicle 705 from the front wheel well to the back wheel well of the electric vehicle 705. The rear portion 725 can include the portion of the electric vehicle 705 from the back wheel well to the back bumper of the electric vehicle 705.

The battery pack 505 that includes at least one battery module 100 having cold plate 130 and a battery monitoring unit 140 can be installed or placed within the electric vehicle 705. For example, the battery pack 505 can couple with a drive train unit of the electric vehicle 705. The drive train unit may include components of the electric vehicle 705 that generate or provide power to drive the wheels or move the electric vehicle 705. The drive train unit can be a component of an electric vehicle drive system. The electric vehicle drive system can transmit or provide power to different components of the electric vehicle 705. For example, the electric vehicle drive train system can transmit power from the battery pack 505 to an axle or wheels of the electric vehicle 705. The battery pack 505 can be installed on the chassis 710 of the electric vehicle 705 within the front portion 715, the body portion 720 (as depicted in FIG. 7), or the rear portion 725. A first bus-bar 735 and a second bus-bar 730 can be connected or otherwise be electrically coupled with other electrical components of the electric vehicle 705 to provide electrical power from the battery pack 505 to the other electrical components of the electric vehicle 705.

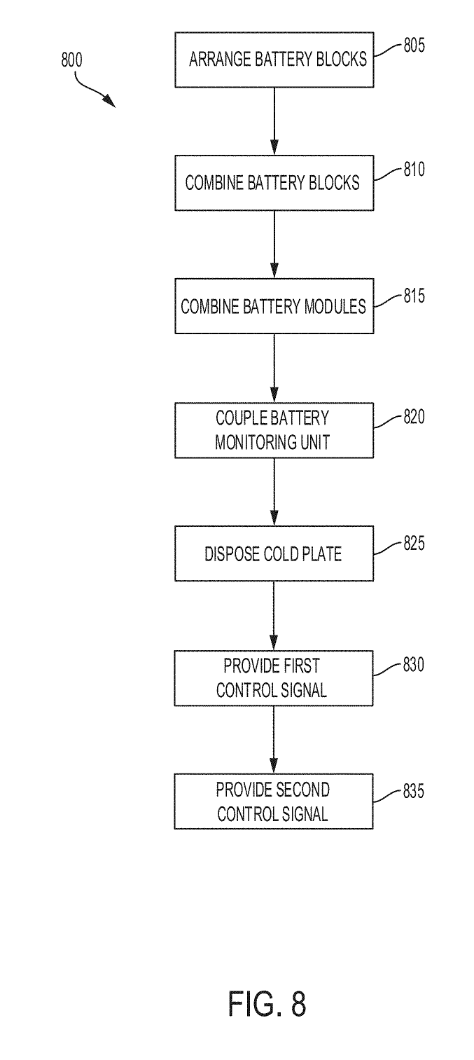

FIG. 8, among others, depicts an example embodiment of a method 800 for providing an energy storage device. The method 800 can include arranging battery blocks 105 (ACT 805). For example, the method can include arrange a plurality of battery blocks 105 to form a battery module 100. Each of the battery blocks 105 can include a plurality of battery cells 110. Arranging the battery blocks 105 can include electrically connecting and physically arranging a plurality of battery cells 110 of a battery block 105 to form a modular unit or battery module 100 for storing energy. The plurality of battery cells 110 can be electrically coupled in parallel with one another to provide a battery block 105.

The plurality of battery cells 110 can be arranged by spatially separating each battery cell 110 of the plurality of battery cells 110 from each of at least one adjacent battery cell 110 by 1.2 millimeter (mm) or less to form a battery block 105. The plurality of battery cells 110 can be evenly spaced across a surface of a first cell holder 115 and second cell holder 120. The plurality of battery cells 110 can be disposed at predetermined positions along a surface of a first cell holder 115 and second cell holder 120. The spacing between the battery cells 110 can vary and can be selected based at least in part on the dimensions of a battery block 105 the battery cells 110 are incorporated within. Each of the plurality of battery cells 110 can have a voltage of up to 5 volts across terminals of the corresponding cell.

The battery cells 110 can be provided or disposed in the battery blocks 105 and can be arranged such that they form one or more rows and one or more columns of battery cells 110. The battery cells 110 can be arranged spatially relative to one another to reduce overall volume of the battery block 105, to allow for the minimum cell to cell spacing (e.g., without failure or degradation in performance), or to allow for an adequate number of vent ports. For example, the battery cells 110 can arrange in a slanted or offset formation relative to one another. The battery cells 110 can be placed in various other formations or arrangements.

Each of the battery cells 110 in a common battery block 105 (e.g., same battery block 105) can be spaced from a neighboring or adjacent battery cell 110 in all directions by a distance that ranges from 0.5 mm to 3 mm, inclusive (e.g., 1.5 mm spacing between each battery cell 110, 2 mm spacing between each battery cell 110). The battery cells 110 in a common battery block 105 can be uniformly spaced, or evenly spaced, or one or more battery cells 110 in a common battery block 105 can be spaced one or more different distances from another one or more battery cells 110 of the common battery block 105.

The battery cells 110 between different battery blocks 105 can be spaced a distance in a range from 2 mm to 6 mm, inclusive. For example, the method 800 can include spatially separating a first cylindrical battery cell 110 of the battery block 105 from a second cylindrical battery cell 110 of the one or more other battery blocks 105 by at least 4.5 millimeter (mm). The distances between the battery cells 110 of different battery blocks 105 can vary and can be selected based at least in part on the dimensions of the battery blocks 105, electrical clearance or creepage specifications, or manufacturing tolerances for the respective battery module 100.

Method 800 can include combining multiple battery blocks 105 (ACT 810). For example, the battery blocks 105 can combine or couple with one or more other battery blocks 105 to from a battery module. The battery blocks 105 can couple with each other using various connections, such as but not limited to ribbonbond interconnects. For example, a first plurality of ribbonbond interconnects can couple positive terminals of the battery blocks 105 and a second plurality of ribbonbond interconnects can couple negative terminals of the battery blocks 105. The ribbonbond interconnects can couple a plurality of battery blocks 105 in series and form a current path having a predetermined shape. For example, the current path can correspond to the flow of current from one battery block 105 to a second, different battery block 105 in a plurality of battery blocks 105. A plurality of electrical pathways or a plurality of current paths can be formed from a first current collector (e.g., positive current collector, negative current collector) of the first battery block 105 to a second current collector (e.g., positive current collector, negative current collector) of the second battery block 105 using the first plurality of ribbonbond interconnects. The plurality of electrical pathways or the plurality of current paths 230 can have the same shape or one or more can have different shapes.

Multiple battery blocks 105 can be electrically coupled with each other to form a battery module 100. Multiple battery modules 100 can be electrically coupled with each other to form a battery pack 505. The number of battery blocks 105 in a single battery module 100 can vary and be selected based at least in part on a desired capacity of the respective battery module 100. The number of battery modules 100 in a single battery pack 505 can vary and be selected based at least in part on a desired capacity of the respective battery pack 505.

Method 800 can include combining multiple battery modules 100 (ACT 815). For example, the battery modules 100 can combine with one or more other battery modules 100 to form a battery pack 505. For instance, a high-torque motor may be suitably powered by a battery pack 505 formed with multiple battery cells (e.g., 500 cells), blocks 105 or modules 100 connected in parallel to increase capacity and to increase current values (e.g., in Amperes or amps) that can be discharged. A battery block 105 can be formed with 20 to 50 cells for instance, and can provide a corresponding number of times the capacity of a single cell.

The battery module 100 having one or more battery blocks 105 can provide flexibility in the design of the respective battery module 100 or a battery pack 505 with initially unknown space constraints and changing performance targets. For example, standardizing and using small battery blocks 105 can decrease the number of parts (e.g., as compared with using individual cells) which can decrease costs for manufacturing and assembly. The battery module 100 having one or more battery blocks 105 as disclosed herein can provide a physically smaller, modular, stable, high capacity or high power device that is not available in today's market, and can be an ideal power source that can be packaged into various applications. The battery block 105 and the one or more other battery blocks 105 can be held using a physical structure 160 of the battery module 100. The physical structure 160 can include a non-conductive layer or material formed around (e.g., enclosing) the different battery blocks 105. The physical structure 160 can include a flexible material or strap disposed around the different battery blocks 105 to hold the battery blocks 105 together.

The battery cells 110 can be individually removable, replaceable, or serviceable from a battery block 105. For example, each of the battery cells 110 can be individually replaceable from a battery block 105 and replaceable by another battery cell 110. The battery blocks 105 can be individually removable, replaceable, or serviceable from a battery module 100. For example, each of the battery blocks 105 can be individually replaceable from a battery module 100 and replaceable by another battery block 105. The battery modules 100 can be individually removable, replaceable, or serviceable from a battery pack 505. For example, each of the battery modules 100 can be individually replaceable from a battery pack 505 and replaceable by another module 100.

The method 800 can include coupling a battery monitoring unit 140 (ACT 820). For example, a battery monitoring unit 140 can couple with at least one battery module 100 of the plurality of battery modules 100 of the battery pack 505. For example, the battery monitoring unit 140 can be incorporated within the battery module 100 to monitor and control the battery module 100. The battery monitoring unit 140 can include or be formed as a circuit board or include circuit and computer components disposed on, formed on, or embedded on a non-conductive layer or material. The battery monitoring unit 140 can coupled with each battery cell 110, each battery block 105, each battery module 100, or cold plate 130 through one or more BMU connectors 145. For example, the BMU connectors 145 can include signal paths (e.g., wires, conductive traces) to couple the battery monitoring unit 140 with each battery cell 110, each battery block 105, each battery module 100, or cold plate 130.

The battery monitoring unit 140 can include a module level component (e.g., battery module 100 level component) that communicates data about one or more battery modules 100 (or one or more battery blocks 105, one or more battery cells 110) to a battery pack level monitoring system or battery pack level monitoring system. For example, the battery monitoring unit 140 can collect or receive data such as, but not limited to, voltage data, temperature data, humidity data, and power balance data (e.g., between battery blocks 105, between battery cells 110). The battery monitoring unit 140 can use the data to balance the battery blocks 105 or the battery cells 110 forming the respective battery module to maintain a near identical voltage level between the battery blocks 105 or battery cells 110. For example, the battery monitoring unit 140 can use the data to balance the battery blocks 105 or the battery cells 110 forming the respective battery module to maintain the same voltage level between the battery blocks 105 or battery cells 110. The battery monitoring unit 140 can include or be coupled with one or more sensors (e.g., voltage sensors, temperature sensors, humidity sensors, power sensors) to collect or receive data such as, but not limited to, voltage data, temperature data, humidity data, and power balance data. The sensors can couple with the battery module 100 through a direct connection or be plugged into one or more ports of the battery monitoring unit 140. For example, the sensors can couple with the battery module 100 through a wire bond, ribbonbond, solder connection (e.g., directly soldered to battery monitoring unit 140), or mounted to a circuit portion of the battery monitoring unit 140. The battery monitoring unit 140 can couple with a battery pack level monitoring system using a wiring harness or an alternative wireless form of communication.

The method 800 can include disposing a cold plate 130 (ACT 825). For example, disposing a cold plate 130 can be disposed between a surface of the battery module 100 and the battery monitoring unit 140. The cold plate 130 can couple with the battery module 100 and the battery monitoring unit 140. The cold plate 130 can receive control signals from the battery monitoring unit 140 to provide levels of cooling to at least a subset of the plurality of battery blocks 105 of the first battery module 100. For example, at least one cold plate 130 can couple with at least one battery module 100 of the plurality of battery modules 100 of the battery pack 505. For example, the cold plate 130 can be incorporated within or as part of the battery module 100. The cold plate 130 can include one or more cooling plates or cooling units. The cooling plates or cooling units can couple with each battery cell 110, each battery block 105, each battery module 100, and so on. For example, the cold plate 130 can be disposed such that it is in contact with, disposed proximate to, or disposed within a predetermined distance from at least one surface or portion of each battery cell 110, each battery block 105, each battery module 100, or battery pack 505. The cold plate 130 can couple with or adhered with at least one surface or portion of each battery cell 110, each battery block 105, each battery module 100, or battery pack 505.

The battery module 100 can include multiple cold plates 130 coupled with each other to form a layered cold plate 130. For example, the cold plates 130 can be coupled with or otherwise incorporated as part of a battery module 100. The battery module 100 can couple with and fastened within a battery pack 505 with one or more other battery modules 100, each having one or more cold plates 130. Within the battery pack 505, the cold plates 130 can couple with one or more coolant connections from one or more coolant manifolds of the battery pack 505. For example, the coolant connections can include, but not limited to, a rubber hose with worm gear clamps, spring clamps, or crimped clamps. The coolant connections can include fittings, such as but not limited to, quick release fitting or quick disconnect fittings, for ease of installation and removal from the battery pack 505 or for coupling with the respective cold plates 130. The fittings can be designed such that coolant does not leak during disassembly of the coolant connectors from the battery pack 505 or the respective cold plates 130. The coolant manifold can couple with a housing of the battery pack 505. For example, the coolant manifold can be fastened, clipped, snapped, or adhered to the housing of the battery pack 505.

The distance of the cold plate 130 from a battery cell 110, battery block 105, battery module 100 or battery pack 505 can be selected such that the cold plate 130 can provide cooling (e.g., active cooling) to each battery cell 110, each battery block 105, each battery module 100, or battery pack 505 to regulate a temperature of each battery cell 110, each battery block 105, each battery module 100, or battery pack 505. The cold plate 130 can be coupled with or in contact with at least one surface of at least one battery cell 110, at least one battery block 105, at least one battery module 100, or the battery pack 505. The cold plate 130 can provide heat dissipation to each battery cell 110, each battery block 105, each battery module 100, or battery pack 505 to regulate a temperature of each battery cell 110, each battery block 105, each battery module 100, or battery pack 505.

The method 800 can include providing a first control signal (ACT 830). For example, the battery monitoring unit 140 can provide a first control signal. The first control signal can identify a first battery module 100 of the plurality of battery modules 100 and can identify a first climate control parameter for the first battery module 100. Based on the first control signal, the cold plate 130 can apply the first climate control parameter to the first battery module 100. For example, the battery monitoring unit 140 can couple with the cold plate 130 such that the battery monitoring unit 140 can control or independently control the cold plate 130. For example, a wire can couple the battery monitoring unit 140 to the cold plate 130. The battery monitoring unit 140 can be communicatively coupled with the cold plate. The battery monitoring unit 140 can generate and transmit control signals indicating a temperature or operating range for the cold plate 130. The battery monitoring unit 140 can generate different control signals for different regions of the battery pack 505, different battery modules 100, different battery blocks 105, or different battery cells 110. The control signals can identify a climate control parameter. The climate control parameters can include, but not limited to, element status (e.g., on/off), a current level, a voltage level, or a temperature level. Thus, the climate control parameters can be used to activate or deactivate a component of the battery pack 505, modify a current level, modify a voltage level, or modify a temperature level. Thus, the control signals can be generated having one or more climate control parameters. The climate control parameters can include control signals to instruct the cold plate 130 to provide cooling at a predetermined cooling level to a respective component of the battery pack 505, as indicated in the control signal. The climate control parameters can include control signals that instruct the cold plate 130 to provide cooling a predetermined cooling level or temperature range for the battery pack 505, for one or more battery modules 100, for one or more battery blocks 105, or for one or more battery cells 110. The climate control parameters can include control signals that instruct the cold plate 130 to provide cooling a predetermined cooling level or temperature range for portions or regions of the battery pack 505, portions or regions of one or more battery modules 100, portions or regions of one or more battery blocks 105, or portions or regions for one or more battery cells 110. The control signals can identify the intended battery pack 505, intended one or more battery modules 100, intended one or more battery blocks 105, or intended one or more battery cells 110. Each of the control signals can include different control parameters. The cold plate 130 can receive the first control signal and apply the first climate control parameter indicated in the first control signal to the identified battery module 100, battery block 105, or battery cell 110 identified in the first control signal.

The method 800 can include providing a second control signal (ACT 835). For example, the battery monitoring unit 140 can provide a second control signal. The second control signal can identify a second battery module 100 of the plurality of battery modules 100 and can identify a second climate control parameter for the second battery module 100. Based on the second control signal, the cold plate 130 can apply the second climate control parameter to the second battery module 100. The cold plate 130 can receive the second control signal and apply the second climate control parameter indicated in the second control signal to the identified battery module 100, battery block 105, or battery cell 110 identified in the second control signal.

The cold plate 130 can use the control signals and the climate control parameters to provide different levels of cooling to different portions of the battery cells 110, battery blocks 105, battery modules 100, or battery pack 505 responsive to the control signals from the monitoring circuitry 140. For example, the battery monitoring unit 140 can generate a first control signal having a first climate control parameter. The first climate control parameter can indicate a first cooling level for a first portion or unit of the battery cells 110, battery blocks 105, battery modules 100, or battery pack 505. The battery monitoring unit 140 can generate a second control signal having a second climate control parameter. The second climate control parameter can indicate a second, different cooling level for a second, different portion or unit of the battery cells 110, battery blocks 105, battery modules 100, or battery pack 505. The number of climate control parameters, the number of levels of cooling (e.g., more than two) or number of portions or units (e.g., more than two) can vary and be selected based at least in part on a size the battery pack 505 or an application of the battery pack 505. The battery monitoring unit 140 can transmit the control signals to cold plate 130 through the one or more wires coupling them. The battery monitoring unit 140 can transmit the control signals to cold plate 130 through a wireless communication link communicatively coupling the battery monitoring unit 140 and the cold plate 130.

The battery monitoring unit 140 can receive or report a status of one or more battery cells 110, one or more battery blocks 105, one or more battery modules 100, or the battery pack 505. For example, the battery monitoring unit 140 can communicatively couple with an output for each of the battery cells 110, each of the battery blocks 105, each of the battery modules 100, or the battery pack 505. The battery monitoring unit 140 can receive a status report from or corresponding to one or more battery cells 110, one or more battery blocks 105, one or more battery modules 100, or the battery pack 505 through the respective output connection. The battery monitoring unit 140 can receive information from the output connections, such as but not limited to, information on current, voltage or temperature. The status report can indicate a failure or malfunction of one or more battery cells 110, one or more battery blocks 105, one or more battery modules 100, or the battery pack 505. The failure or malfunction can be detected by comparing the received current data, voltage data, or temperature data to one or more threshold values. The threshold values can correspond to a desired current, voltage, or temperature level or a current limit, voltage limit, or temperature limit for a battery cell 110, battery block 105, battery module 100, or battery pack 505.

The battery monitoring unit 140 can control or independently control a battery cell 110, battery block 105, battery module 100, or battery pack 505. For example, responsive to receiving the information from the output connections, the battery monitoring unit 140 can generate and transmit control signals indicating current level, voltage level, or temperature range for the corresponding battery cell 110, battery block 105, battery module 100, or battery pack 505. The battery monitoring unit 140 can generate an alert or notification, for example, a notification for a user of the battery pack 505 to indicate when a particular battery cell 110, battery block 105, battery module 100, or battery pack 505 should be repaired, replaced, or serviced.

The battery monitoring unit 140 of the battery module 100 can be removable from the battery module 100 or battery pack 505 and replaceable by another monitoring circuitry 140. For example, the battery monitoring unit 140 can be disconnected from the battery module 100 or battery pack 505 and replaced with another battery monitoring unit 140 without impacting the operation of the battery module 100 or battery pack 505 or modifying the arrangement of the battery cells 110, battery blocks 105, the battery modules 100 or battery pack 505.

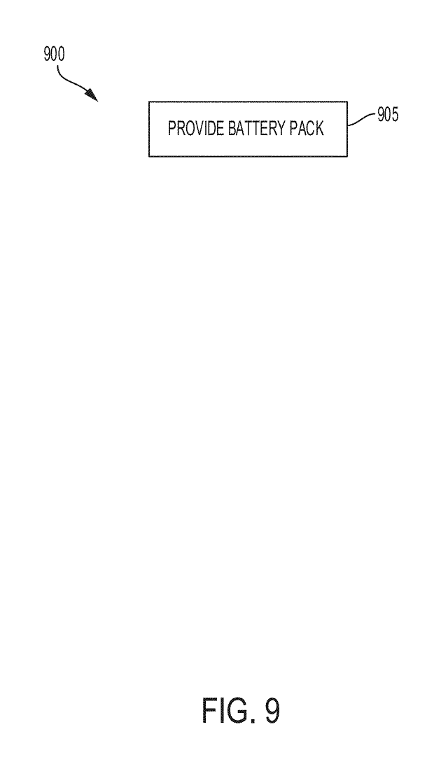

FIG. 9 depicts an example embodiment of a method 900. The method 900 can include providing a battery pack 505 to power an electric vehicle 705 (ACT 905). The battery pack 505 can reside in the electric vehicle 705. The battery pack 505 can include a plurality of battery modules 100. The plurality of battery modules 100 can provide a battery pack capacity and battery pack voltage. Each of the plurality of battery modules 100 can have a pair of battery module terminals 510, 515. Each of the plurality of battery modules 100 can include a plurality of battery blocks 105. Each of the battery blocks 105 can have a pair of battery block terminals 430, 435. Each pair of battery block terminals 430, 435 can have a predefined maximum voltage across the respective pair of battery block terminals. Each pair of battery block modules terminals 510, 515 can have a voltage across the respective pair of battery module terminals 510, 515 that is greater than the voltage across each pair of battery block terminals 430, 435. Each of the battery blocks 105 can include a plurality of cylindrical battery cells 110 connected in parallel. Each of the cylindrical battery cells 110 can have a pair of battery cell terminals 415, 420. Each pair of battery cell terminals 415, 420 can have the predefined maximum voltage across the respective pair of battery cell terminals 415, 420. The battery pack 505 can include a battery monitoring unit 140 coupled with a first battery module 100 of the plurality of battery modules 100. The battery pack 505 can include a cold plate 130 coupled with the first battery module 100 and the battery monitoring unit 140. The cold plate 130 can receive control signals from the battery monitoring unit 140 to provide levels of cooling to at least a subset of the plurality of battery blocks 105 of the first battery module 100.

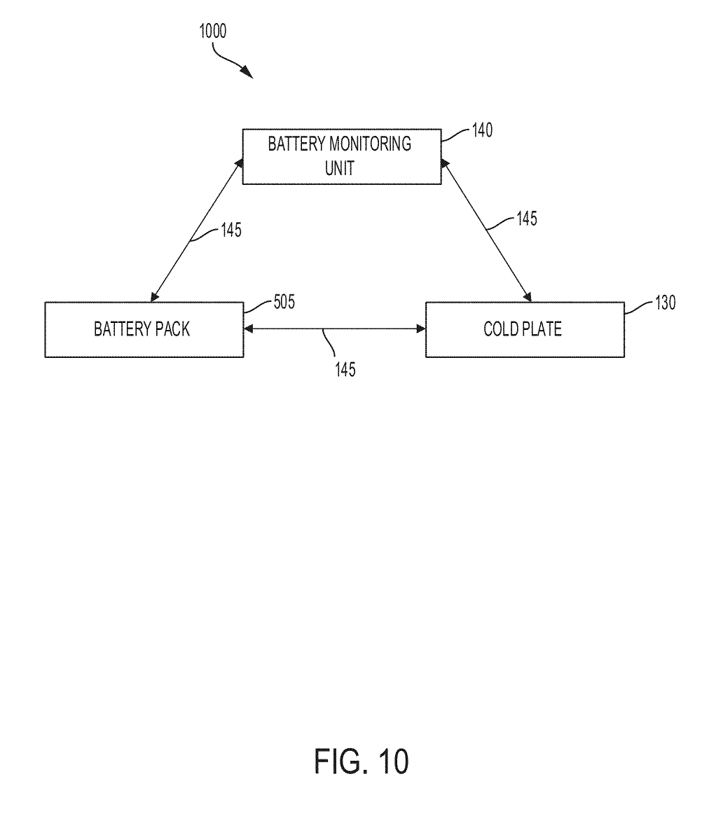

FIG. 10 depicts an example electric vehicle battery pack system 1000 that powers electric vehicles. The system 1000 can include at least one battery monitoring unit 140, at least one cold plate 130, and at least one battery pack 505. The battery monitoring unit 140 can couple with the cold plate 130 though at least one BMU connector 145 to receive signals or to provide signals. The battery monitoring unit 140 can couple with the battery pack 505 though at least one BMU connector 145 to receive signals or to provide signals. The battery pack 505 can couple with the cold plate 130 though at least one BMU connector 145 to receive signals or to provide signals. For example, the battery pack 505 can include a battery pack monitoring system that receives signals (e.g., status signals, temperature signals) from the cold plate 130 or provides signals (e.g., control signals) to the cold plate 130. The battery pack 505 can include a plurality of battery modules 100. Each of the battery modules 100 of the battery pack 505 can include a plurality of battery blocks 105. The battery blocks 105 can include a plurality of battery cells 110. Each battery module 100 can include a physical structure 160 or holder to support, hold or partially enclose the corresponding battery blocks 105, at least one cold plate 130, or at least one battery monitoring unit 140 of the respective battery module 100.

The battery monitoring unit 140 can include hardware and software to provide monitoring and controls to the battery packs 505, to one or more battery modules 100 within the battery pack 505, to one or more battery blocks 105 within a battery module 100, or one or more battery cells 110 within a battery block 105. For example, the battery monitoring unit 140 can include a processor, a memory, and one or more sensing devices (e.g., temperature sensing devices) to monitor the different components of the battery pack 505. The battery monitoring unit 140 can include a circuit board, such as but not limited to a printed circuit board. The battery monitoring unit 140 can include circuit components coupled with, disposed on, or embedded in a non-conductive material or layer to form the battery monitoring unit 140.

The processor of the battery monitoring unit 140 can monitor the battery pack 505, each of the battery modules forming the battery pack 505, each of the battery blocks 105 forming a battery module 100 and each of the battery cells 110 forming a battery block 105. For example, the battery monitoring unit 140 can couple with outputs of the battery cells 110, outputs of the battery blocks 105, outputs of the battery modules 100 or an output of the battery pack 505 to receive information, such as but not limited to current data, voltage data, or temperature data. The processor can store the current data, voltage data, or temperature data in the memory of the battery monitoring unit 140. The processor of the battery monitoring unit 140 can use the current data, voltage data, or temperature data to generate controls signals for the battery pack 505, each of the battery modules forming the battery pack 505, each of the battery blocks 105 forming a battery module 100 and each of the battery cells 110 forming a battery block 105. For example, responsive to receiving current data, voltage data, or temperature data, the processor of the battery monitoring unit 140 can generate control signals to modify a current level, voltage level, or temperature level of the respective the battery pack 505, the battery module 100, the battery blocks 105, or the battery cells 110 receiving the respective control signals. The processor of the battery monitoring unit 140 can generate control signals to activate or deactivate (e.g., turn on, turn off) the cold plate 130, the battery pack 505, one or more battery modules 100, one or more battery blocks 105, or one or more battery cells 110 receiving the respective control signals. The processor of the battery monitoring unit 140 can generate different control signals for different regions of the battery pack 505, different battery modules 100, different battery blocks 105, or different battery cells 110. For example, the control signals can identify the intended battery pack 505, intended one or more battery modules 100, intended one or more battery blocks 105, or intended one or more battery cells 110. Each of the control signals can include different control parameters. The climate control parameters can include, but not limited to, element status (e.g., on/off), a current level, a voltage level, or a temperature level. Thus, the climate control parameters can be used to activate or deactivate a component of the battery pack 505, modify a current level, modify a voltage level, or modify a temperature level. For example, control signals can be generated by the processor of the battery monitoring unit 140 for the cold plate 130 that include climate control parameters. The climate control parameters can include control signals that instruct the cold plate 130 to provide more, less, or the same cooling at a predetermined cooling level to a respective component of the battery pack 505, as indicated in the control signal.

For example, climate control parameters can include control signals that instruct the cold plate 130 to provide cooling a predetermined cooling level or temperature range for the battery pack 505, for one or more battery modules 100, for one or more battery blocks 105, or for one or more battery cells 110. The climate control parameters can include control signals that instruct the cold plate 130 to provide cooling a predetermined cooling level or temperature range for portions or regions of the battery pack 505, portions or regions of one or more battery modules 100, portions or regions of one or more battery blocks 105, or portions or regions for one or more battery cells 110. The processor of the battery monitoring unit 140 can determine, according to the monitoring, to control the cold plate 130 and maintain the battery pack 505, one or more battery modules 100, one or more battery blocks 105, or one or more battery cells 110 within a temperature range. The processor of the battery monitoring unit 140 can determine, according to the monitoring, to control operation of the cold plate 130 to control, regulate, increase or reduce the temperature within the battery pack 505, within one or more battery modules 100, within one or more battery blocks 105, or within one or battery cells 110. For example, the processor of the battery monitoring unit can generate controls signals to turn on the cold plate 130. The processor of the battery monitoring unit can generate controls signals to turn off the cold plate 130. The processor of the battery monitoring unit can generate controls signals to open one or more valves or cooling channels within the cold plate 130 to increase or reduce a temperature of the cold plate 130. For example, the processor of the battery monitoring unit can generate controls signals provide coolant fluid to one or more cooling channels within the cold plate 130 or release coolant fluid from one or more coolant channels within the cold plate 130. The control signals can be generated for different battery modules 100, different battery blocks 105, or different battery cells 110 can be generated simultaneously. The control signals can be generated for different battery modules 100, different battery blocks 105, or different battery cells 110 can in a predetermined order. For example, the control signals can be generated for different battery modules 100, different battery blocks 105, or different battery cells 110 based in part on a position within the battery pack 505. the control signals can be generated for different battery modules 100, different battery blocks 105, or different battery cells 110 based in part on an alert indicating an issue within the battery pack 505, with at least one battery module 100, with at least one battery block 105 or with at least one battery cell 110. For example, the processor of the battery monitoring unit 140 can monitor the cold plate 130, the battery pack 505, one or more battery modules 100, one or more battery blocks 105, or one or more battery cells 110 and generate or report a status or provide local diagnostics of the corresponding cold plate 130, battery pack 505, one or more battery modules 100, one or more battery blocks 105, or one or more battery cells 110. The battery monitoring unit 140 can generate an alert or notification, for example, a notification for a user of the battery pack 505 to indicate when a particular battery cell 110, battery block 105, battery module 100, or battery pack 505 should be repaired, replaced, or serviced.

The battery monitoring unit 140 can be a separate component from the battery pack 505. For example, the battery monitoring unit 140 can be communicatively coupled with the battery pack 505. The battery monitoring unit 140 can be a component of the battery pack 505 or a battery module 100. For example, the battery monitoring unit 140 can be disposed within and coupled with at least one surface of the battery pack 505, at least one battery module 100 within the battery pack 505, at least one battery block 105 within a battery module 100, or at least one battery cell 110 within a battery block 105. The battery monitoring unit 140 can be removable from the battery pack 505 or from a battery module 100 and replaceable by another battery monitoring unit 140. The battery monitoring unit 140 can be disconnected from the battery pack 505 or battery module 100 and replaced with another battery monitoring unit 140 without impacting the operation of the battery pack 505 or the battery module 100 or modifying the arrangement of the battery cells 110, battery blocks 105, the battery modules 100 or battery pack 505. The battery monitoring unit 140 can be disconnected from the battery pack 505 or battery module 100 and replaced with another battery monitoring unit 140 without damaging or modifying the battery pack 505 or battery module 100.

The cold plate 130 can include a single cold plate 130 coupled with each of the battery blocks 105 forming a battery module 100 or the cold plate 130 can include multiple cold plates 130. For example, at least one cold plate 130 can be coupled with individual battery modules 100, individual battery blocks 105, or individual battery cells 110. The cold plate(s) 130 can include fluid channels to run water or other fluid or coolant through the cold plate 130 to draw heat from the battery blocks 105 or any of their components. At least one cold plate 130 can be coupled with subsets (e.g., multiple) battery modules 100, subsets of battery blocks 105, or subsets of battery cells 110. The cold plate 130 can include a single cooling channel or multiple cooling channels. The cold plate 130 can include at least one orifice that can function as a coolant input and a coolant output. The cold plate 130 can include at least one coolant input or at least one coolant output. The cooling channels 130 of the cold plate may include at least one coolant input or at least one coolant output to receive or release coolant fluid, respectively. The cold plate can include a single cooling zone or multiple cooling zones. For example, the cold plate 130 can include at least one cooling zone coupled with at least one battery pack 505, at least one battery module 100, at least one battery block 105 or at least one battery cell 110. The cold plate 130 can include a single cooling zone coupled with each of the battery pack 505, each of the battery modules 100, each of the battery blocks 105 or each of the battery cells 110.

The cold plate 130 can receive control signals from the battery monitoring unit 140 having climate control parameters. The cold plate 130 can use the climate control parameters to provide active cooling to at least one surface of the battery pack 505, one or more battery modules 100, one or more battery blocks 105, or one or more battery cells 110. The climate control parameters can correspond to or include a particular temperature or a temperature range. The climate control parameters can correspond to or include instructions to turn on one or more cooling zones. The climate control parameters can correspond to or include instructions to turn off one or more cooling zones. The climate control parameters can correspond to or include instructions to decrease a temperature of one or more cooling zones. The climate control parameters can correspond to or include instructions to increase a temperature of one or more cooling zones. The climate control parameters can correspond to or include instructions to open at least one valve to at least one cooling channel within the cold plate 130. The climate control parameters can correspond to or include instructions to close at least one valve to at least one cooling channel within the cold plate 130. The climate control parameters can correspond to or include instructions to increase coolant fluid flow through at least one cooling channel within the cold plate 130. The climate control parameters can correspond to or include instructions to decrease coolant fluid flow through at least one cooling channel within the cold plate 130. For example, the cold plate 130 can be in contact with at least one surface of the battery pack 505, at least one surface of a battery module 100, at least one surface of a battery block 105, or at least one surface of a battery cell 110 to provide active cooling.

The cold plate 130 can provide climate control parameters (e.g., different levels of cooling or temperature control) to different portions of the battery pack 505, one or more battery module 100, one or more battery blocks 105, or one or more battery cells 110, for example, through one or more cooling zones. For example, the cold plate 130 can receive a first control signal having a first climate control parameter. The first climate control parameter can correspond to a first level of cooling for a first portion of the battery module 100. The cold plate 130 can receive a second control signal having a second climate control parameter. The second climate control parameter can correspond to a second, different level of cooling (e.g., lower temperature than indicated in the first climate control parameter) for a second, different portion of the battery module 100. The different portions can include different battery blocks 105, different groupings of battery blocks 105, different battery cells 110 or different groupings of battery cells 110. For example, the different portions can include different subsets or different groupings of battery cells 110 within a common battery block 105. The cold plate 130 can include a single cooling plate or multiple cooling plates. For example, the number of cooling plates of the cold plate 130 can correspond to the number of battery blocks 105 of the battery module 100 (e.g., one cooling plate coupled with at least one battery block 105). The cooling plate or cooling plates forming the cooling system can be individually removable (from each other) and replaceable. The cold plate 130 can be removable from the battery pack 505 or from a battery module 100 and replaceable by another cold plate 130. The cold plate 130 can be disconnected from the battery pack 505 or battery module 100 and replaced with another cold plate 130 without impacting the operation of the battery pack 505 or the battery module 100 or modifying the arrangement of the battery cells 110, battery blocks 105, the battery modules 100 or battery pack 505. The cold plate 130 can be disconnected from the battery pack 505 or battery module 100 and replaced with another cold plate 130 without damaging or modifying the battery pack 505 or battery module 100.

While acts or operations may be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. For example the voltage across terminals of battery cells can be greater than 5V. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An electric vehicle battery pack system to power electric vehicles, comprising:
a battery pack to power an electric vehicle, the battery pack residing in an electric vehicle and comprising a plurality of battery modules;
each of the plurality of battery modules having a plurality of battery blocks, and each of the plurality of battery modules having a pair of battery module terminals, each pair of battery module terminals having a battery module voltage across the pair of battery module terminals;
each of the battery blocks having a plurality of cylindrical battery cells connected in parallel, and each of the battery blocks having a pair of battery block terminals with a defined maximum voltage across the pair of battery block terminals that is less than the battery module voltage;
each of the cylindrical battery cells having a pair of battery cell terminals, each pair of battery cell terminals having the defined maximum voltage across the pair of battery cell terminals;
a battery monitoring unit coupled with a first battery module of the plurality of battery modules; and
a cold plate coupled with the first battery module and the battery monitoring unit;
the battery monitoring unit to provide a first control signal, the first control signal identifies a first battery module of the plurality of battery modules and identifies a first climate control parameter for the first battery module;
based on the first control signal, the cold plate applies the first climate control parameter to the first battery module;
the battery monitoring unit to provide a second control signal, the second control signal identifies a second battery module of the plurality of battery modules and identifies a second climate control parameter for the second battery module; and
based on the second control signal, the cold plate applies the second climate control parameter to the second battery module.

2. The system of claim 1, wherein the first battery module of the plurality of battery modules comprises:
a physical structure for holding a plurality of battery blocks of the first battery module.

3. The system of claim 1, comprising:
each of the plurality of battery modules removable from the battery pack and replaceable back into the battery pack.

4. The system of claim 1, comprising:
the battery monitoring unit to report on a status of the first battery module to enable a decision on whether to remove the first battery module from the battery pack.

5. The system of claim 1 comprising:
a plurality of cold plates, each of the cold plates coupled with at least one surface of at least one battery block of the plurality of battery blocks of the first battery module, and each of the cold plates coupled with the battery monitoring unit.

6. The system of claim 1, wherein each cylindrical battery cell of the plurality of battery cells is spatially separated from each of at least one adjacent cylindrical battery cell by less than 1.2 millimeter (mm).

7. The system of claim 1, comprising:
a first cylindrical battery cell of a first battery block spatially separated from a second cylindrical battery cell of the one or more other battery blocks by at least 4.5 millimeter (mm).

8. The system of claim 1 wherein:
each of the plurality of battery blocks of each of the first battery module includes an output that is communicatively coupled to the battery monitoring unit.

9. The system of claim 8, comprising:
the battery monitoring unit to monitor the plurality of battery blocks of the first battery module by receiving information from the output of each of the plurality of battery blocks of the first battery module, wherein the information includes current, voltage or temperature of one or more battery blocks of the plurality of battery blocks of the first battery module, and to control the plurality of battery blocks of the first battery module according to the received information.

10. The system of claim 1, wherein the battery monitoring unit of the first battery module is removable from the first battery module and replaceable by another battery monitoring unit.

11. The system of claim 1, wherein the cold plate of the first battery module is removable from the first battery module and replaceable by another cold plate.

12. The system of claim 1, comprising:
the cold plate includes a plurality of cooling zones, each of the cooling zones correspond to at least one battery block of the plurality of battery blocks of the first battery module, and each of the cooling zones coupled with the battery monitoring unit.

13. The system of claim 1, comprising:
the cold plate coupled with at least one surface of each of the battery blocks of the first battery module to provide cooling to the respective battery blocks.

14. The system of claim 1, comprising:
the cold plate disposed between a surface of the battery module and the battery monitoring unit.

15. The system of claim 1, comprising:
the plurality of battery blocks of the first battery module electrically coupled in series.

16. The system of claim 1, comprising:
the battery pack disposed in an inverter module of a drive train unit, the drive train unit having multiple inverter modules.

17. The system of claim 1, comprising:
the battery pack disposed in an inverter module of a drive train unit, the drive train unit disposed in the electric vehicle.

18. A method, comprising:
arranging a plurality of cylindrical battery cells to form a battery block, each of the plurality of cylindrical battery cells having a pair of battery cell terminals, the battery block having a pair of battery block terminals, each pair of the battery cell terminals having a defined maximum voltage across the respective pair of battery cell terminals;
electrically connecting the plurality of cylindrical battery cells in parallel, to cause each pair of the battery block terminals to have the defined maximum voltage across the respective pair of battery block terminals;
combining the battery block with one or more other battery blocks to form a battery module, the battery module having a pair of battery module terminals, the pair of battery module terminals having a maximum voltage across the respective pair of battery module terminals that is greater than the defined maximum voltage across each pair of the battery block terminals;
combining the battery module combinable with one or more other battery modules to form a battery pack having a battery pack capacity and battery pack voltage, the battery module and the one or more other battery modules removable from the battery pack and replaceable by another battery module;
coupling a battery monitoring unit with the battery module; and
disposing a cold plate between a surface of the battery module and the battery monitoring unit, the cold plate coupled with the battery module and the battery monitoring unit;
providing, by the battery monitoring unit, a first control signal to the cold plate, the first control signal identifies a first battery module of the plurality of battery modules and identifies a first climate control parameter for the first battery module;
applying, by the cold plate and based on the first control signal, the first climate control parameter to the first battery module;
providing, by the battery monitoring unit, a second control signal, the second control signal identifies a second battery module of the plurality of battery modules and identifies a second climate control parameter for the second battery module; and
applying, by the cold plate and based on the second control signal, the second climate control parameter to the second battery module.

19. The method of claim 18, comprising:
monitoring, by the battery monitoring unit, the plurality of battery blocks of the battery module by receiving information from the output of each of the plurality of battery blocks of the battery module, wherein the information includes current, voltage or temperature of one or more battery blocks of the plurality of battery blocks of the first battery module, and to control the plurality of battery blocks of the first battery module according to the received information; and
providing, by the cold plate, a level of cooling to each of the plurality of battery blocks responsive to a control signal from the battery monitoring unit.

20. An electric vehicle, comprising:
a battery pack to power an electric vehicle, the battery pack residing in an electric vehicle and comprising a plurality of battery modules;
each of the plurality of battery modules having a plurality of battery blocks, and each of the plurality of battery modules having a pair of battery module terminals, each pair of battery module terminals having a battery module voltage across the pair of battery module terminals;
each of the battery blocks having a plurality of cylindrical battery cells connected in parallel, and each of the battery blocks having a pair of battery block terminals with a defined maximum voltage across the pair of battery block terminals that is less than the battery module voltage;
each of the cylindrical battery cells having a pair of battery cell terminals, each pair of battery cell terminals having the defined maximum voltage across the pair of battery cell terminals;
a battery monitoring unit coupled with a first battery module of the plurality of battery modules; and
a cold plate coupled with the first battery module and the battery monitoring unit;
the battery monitoring unit to provide a first control signal, the first control signal identifies a first battery module of the plurality of battery modules and identifies a first climate control parameter for the first battery module;
based on the first control signal, the cold plate applies the first climate control parameter to the first battery module;
the battery monitoring unit to provide a second control signal, the second control signal identifies a second battery module of the plurality of battery modules and identifies a second climate control parameter for the second battery module; and
based on the second control signal, the cold plate applies the second climate control parameter to the second battery module.
